(19) United States
(12) Patent Application Publication
(10) Pub. No.: US 2018/0324511 A1
(43) Pub. Date: Nov. 8, 2018

(54) SOUND COLLECTION DEVICE

(71) Applicant: SONY CORPORATION, TOKYO (JP)

(72) Inventors: Kohei ASADA, KANAGAWA (JP); Kyosuke MATSUMOTO, KANAGAWA (JP); Yushi YAMABE, TOKYO (JP); Go IGARASHI, TOKYO (JP); Kazuma YOSHII, TOKYO (JP)

(73) Assignee: SONY CORPORATION, Tokyo (JP)

(21) Appl. No.: 15/773,773

(22) PCT Filed: Sep. 27, 2016
(86) PCT No.: PCT/JP2016/078519

§ 371 Date: May 4, 2018

(30) Foreign Application Priority Data
Nov. 25, 2015 (JP) 2015-229315

(51) Int. Cl. H04R 1/04; H04R 1/10; H04R 1/40; H04R 1/08

(52) U.S. Cl. CPC H04R 1/04; H04R 1/105; H04R 1/08; H04R 1/40; H04R 1/1066

(57) ABSTRACT

[Object] To enable capable acquisition of target sounds in a preferred manner while preventing a device from getting larger. [Solution] A sound collection device includes: a plurality of sound collection parts; a supporting member that has a long shape and that supports the plurality of sound collection parts at respective positions different from each other along a long-length direction; and a signal output part that directly or indirectly outputs sound collection results of respective sounds obtained by the plurality of sound collection parts to a signal processing part that acquires a target sound coming from one side of the long-length direction on a basis of the sound collection results.

### TECHNICAL FIELD

The present disclosure relates to sound collection devices.

### BACKGROUND ART

In recent years, since sound analysis technologies have been developed, various kinds of microphones (hereinafter, also referred as “sound collection parts”) using technologies capable of collecting sound (so-called target sound) from a sound source that is a sound collection target with a high S/N ratio (in other words, technologies of adding directivity to the sound collection parts) have been discussed as sound collection devices configured to collect sounds via microphones, for example. For example, Patent Literature 1 discloses an example of the technologies capable of collecting sounds from a sound source that is a sound collection target with a high S/N ratio (so-called beamforming technology).

### CITATION LIST

### Patent Literature

Patent Literature 1: JP 2009-141560A

### DISCLOSURE OF INVENTION

### Technical Problem

Some of the above-described sound collection devices are wearable sound collection devices such as so-called hearing aids. In addition, in recent years, as sizes of various kinds of devices have become smaller, so-called wearable devices have been proposed. The wearable devices are capable of using information processing devices such as so-called smartphones worn on predetermined body parts such as heads. By applying the above-described sound analysis technologies (such as beamforming technologies) to such wearable devices and hearing (or collecting) target sounds in preferred manners, usage scenes thereof are expected to be expanded from not only a scene of using a so-called hearing aid to a scene of watching a show, observing birds, and the like, for example.

On the other hand, sometimes it is difficult to enlarge sizes of wearable devices such as hearing aids because they are mounted on heads of users (such as vicinities of ears). As described above, it is difficult to install a plurality of sound collection parts in a sound collection device with a limited size, for example. As a result, sometimes it is difficult to obtain enough directivity.

Accordingly, the present disclosure proposes a sound collection device capable of acquiring target sounds in a preferred manner while preventing the device from getting larger.

### Solution to Problem

According to the present disclosure, there is provided a sound collection device including: a plurality of sound collection parts; a supporting member that has a long shape and that supports the plurality of sound collection parts at respective positions different from each other along a long-length direction; and a signal output part that directly or indirectly outputs sound collection results of respective sounds obtained by the plurality of sound collection parts to a signal processing part that acquires a target sound coming from one side of the long-length direction on a basis of the sound collection results.

### Advantageous Effects of Invention

As described above, according to the present disclosure, there is provided the sound collection device capable of acquiring target sounds in a preferred manner while preventing the device from getting larger.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram illustrating an example of a schematic configuration of a sound collection device according to an embodiment of the present disclosure.

FIG. 2 is an explanatory diagram illustrating the example of the schematic configuration of the sound collection device according to the embodiment.

FIG. 3 is a block diagram illustrating an example of a functional configuration of the sound collection device according to the embodiment.

FIG. 4 is an explanatory diagram illustrating an example of a schematic configuration of a sound collection device according to a first modification.

FIG. 5 is an explanatory diagram illustrating another example of the schematic configuration of the sound collection device according to the first modification.

FIG. 6 is an explanatory diagram illustrating an example of a configuration of a sound collection unit according to a second modification.

FIG. 7 is an explanatory diagram illustrating an example of a configuration of a sound collection unit according to the second modification.

FIG. 8 is an explanatory diagram illustrating an example of a configuration of a sound collection unit according to the second modification.

FIG. 9 is an explanatory diagram illustrating an example of a configuration of a sound collection unit according to the second modification.

FIG. 10 is an explanatory diagram illustrating an example of a configuration of a sound collection unit according to the second modification.

FIG. 11 is an explanatory diagram illustrating an overview of a sound collection unit according to a third modification.

FIG. 12 is an explanatory diagram illustrating an overview of a sound collection unit according to the third modification.

FIG. 13 is an explanatory diagram illustrating an example of a sound collection system including a sound collection unit according to a fourth modification.

FIG. 14 is an explanatory diagram illustrating an example of a removable sound collection unit according to the fourth modification.

FIG. 15 is an explanatory diagram illustrating the example of the removable sound collection unit according to the fourth modification.

FIG. 16 is an explanatory diagram illustrating an example of schematic configurations of a plug part and a jack part.

FIG. 17 is an explanatory diagram illustrating another example of the removable sound collection unit according to the fourth modification.

FIG. 18 is an explanatory diagram illustrating the another example of the removable sound collection unit according to the fourth modification.

FIG. 19 is an explanatory diagram illustrating another example of the removable sound collection unit according to the fourth modification.

FIG. 20 is an explanatory diagram illustrating the another example of the removable sound collection unit according to the fourth modification.

FIG. 21 is an explanatory diagram illustrating an overview of a sound collection device according to a fifth modification.

FIG. 22 is an explanatory diagram illustrating an example of a sound process performed by the sound collection device according to the fifth modification.

FIG. 23 is an explanatory diagram illustrating another example of the sound process performed by the sound collection device according to the fifth modification.

FIG. 24 is an explanatory diagram illustrating an example of a schematic configuration of a sound collection device according to a sixth modification.

FIG. 25 is an explanatory diagram illustrating another example of the schematic configuration of the sound collection device according to the sixth modification.

FIG. 26 is an explanatory diagram illustrating the another example of the schematic configuration of the sound collection device according to the sixth modification.

FIG. 27 is an explanatory diagram illustrating another example of the schematic configuration of the sound collection device according to the sixth modification.

FIG. 28 is an explanatory diagram illustrating another example of the schematic configuration of the sound collection device according to the sixth modification.

FIG. 29 is an explanatory diagram illustrating an example of a schematic configuration of a sound collection device according to a seventh modification.

FIG. 30 is an explanatory diagram illustrating an example of a schematic configuration of a sound collection device according to an eighth modification.

FIG. 31 is an explanatory diagram illustrating the example of the schematic configuration of the sound collection device according to the eighth modification.

FIG. 32 is an explanatory diagram illustrating the example of the schematic configuration of the sound collection device according to the eighth modification.

FIG. 33 is an explanatory diagram illustrating an overview of a sound collection device according to a ninth modification.

FIG. 34 is an explanatory diagram illustrating another example of the sound collection device according to the ninth modification.

FIG. 35 is an explanatory diagram illustrating an example of a schematic configuration of a sound collection device according to a tenth modification.

FIG. 36 is a diagram illustrating an example of a hardware configuration of the sound collection device according to the embodiment.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that, the description is given in the following order.

### 1. Embodiment

1.1. Schematic configuration
1.2. Functional configuration

### 1.3. Effect

### 2. Modifications

2.1. First modification: Example of configuration related to output of sound collection result
2.2. Second modification: Example of configuration of sound collection unit
2.3. Third modification: Example of arrangement of sound collection parts
2.4. Fourth modification: Example of removable sound collection unit
2.5. Fifth modification: Example of sound process
2.6. Sixth modification: Implementation example to wearable device
2.7. Seventh modification: Control example using detection of speech
2.8. Eighth modification: Example of variable sound collection unit
2.9. Ninth modification: Example of case of causing plurality of sound collection units to cooperate with each other
2.10. Tenth modification: Implementation example of directional speaker
3. Hardware configuration

### 4. Conclusion

### 1. EMBODIMENT

### 1.1. Schematic Configuration

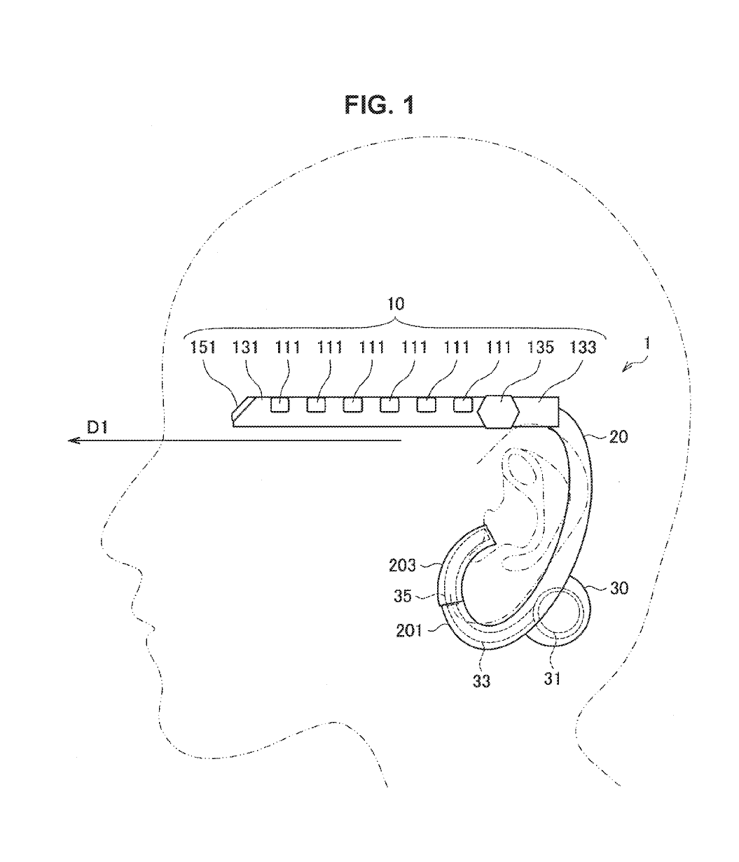

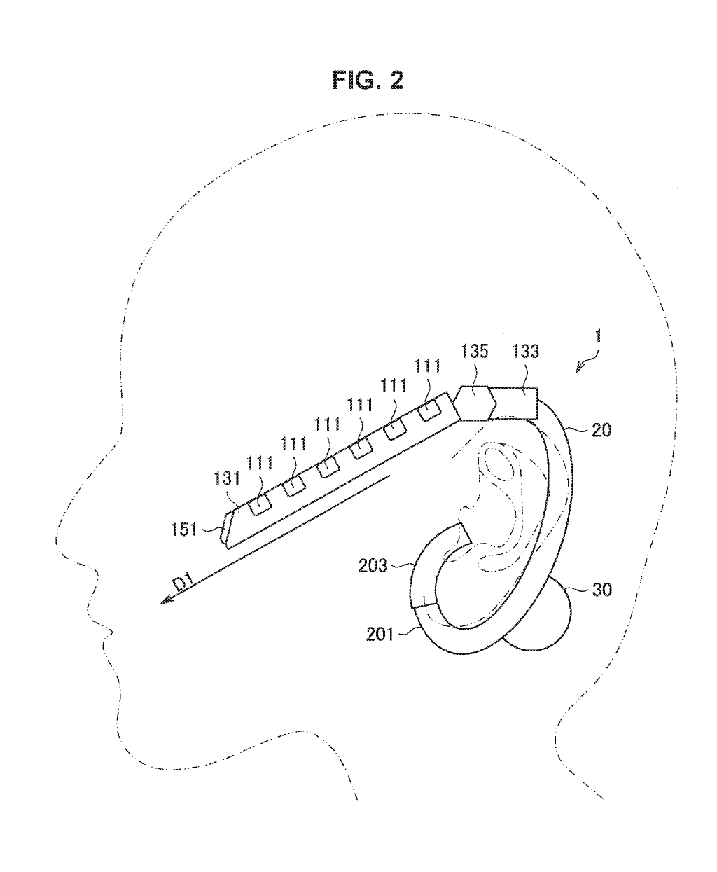

First, with reference to FIG. 1 and FIG. 2, an example of a schematic configuration of a sound collection device according to an embodiment of the present disclosure will be described. FIG. 1 and FIG. 2 are explanatory diagrams illustrating the example of the schematic configuration of the sound collection device according to the embodiment.

As illustrated in FIG. 1, a sound collection device 1 according to the embodiment includes a sound collection unit 10, a wearable part 20, and a driver holder 30. The sound collection device 1 is configured to be worn on a vicinity of an ear.

The sound collection unit 10 includes a plurality of sound collection parts 111, supporting members 131 and 133, and a rotation part 135. In addition, the sound collection unit 10 may include a light-emitting part 151. The supporting member 131 has a long shape and supports the plurality of sound collection parts 111 at respective positions different from each other along a long-length direction. At least a portion of the supporting member 133 is supported by the wearable part 20. This enables the whole sound collection unit 10 is held at a predetermined position with respect to an ear of a user who wears the sound collection device 1. Note that, details of the configuration of the wearable part 20 will be described later.

The light-emitting part 151 may be installed at an end of the supporting member 131 positioned at a front side when the user wears the sound collection device 1 (hereinafter, also referred to as a “front-side end”) among ends of the supporting member 131 in a long-length direction. For example, the light-emitting part 151 includes a light source such as a light-emitting diode (LED). The light-emitting part 151 notifies a user of states of the sound collection unit 10 by using light emitting states. As a specific example, it is possible for the light-emitting part 151 to notify a user that sounds are being collected by performing control such that light is emitted in the case where the sound collection parts 111 are collecting the respective sounds.

Note that, the sound collection unit 10 according to the embodiment controls directivity of sound collection such that a sound from a sound source positioned at the front-end side (such as a front side of a user or a position diagonally in front of the user) of the supporting member 131 in the long-length direction (in other words, arrangement direction of the plurality of sound collection parts 111) is treated as a target sound. Details thereof will be described later.

The rotation part 135 rotatably connects the supporting member 131 with the supporting member 133. Specifically, among the ends of the supporting member 133 in the long-length direction, an end positioned at a rear side (hereinafter, also referred to as a “rear-side end”) when the user wears the sound collection device 1 is connected with the rotation part 135, and the supporting member 131 swings up and down around the rotation part 135. Note that, the mechanism for rotating the rotation part 135 is not specifically limited. For example, the rotation part 135 may be configured to be manually rotated or may be configured to be automatically rotated. In addition, operation related to the rotation of the rotation part 135 may be controlled by the sound collection device 1 itself, or by an external device such as a smartphone, for example.

As illustrated in FIG. 1, in the case where the supporting member 131 swings upward by using the above-described configuration, the supporting member 131 is supported such that the long-length direction of the supporting member 131 (in other words, the front-side end of the supporting member 131) is toward a gaze direction (for example, substantially horizontal direction) of the user wearing the sound collection device 1. Accordingly, in the state illustrated in FIG. 1, directivity of the sound collection unit 10 is controlled such that a sound from a sound source (such as another user or the like) positioned in the gaze direction of the user is collected as a target sound. For example, the reference sign D1 represents an example of a direction of directivity of the sound collection unit 10 regarding sound collection. Note that, in the following description, directions in the other drawings with the reference sign D1 represent examples of the direction of directivity of sound collection to be performed by the sound collection unit 10 (or similar structural element) in a similar way, unless otherwise specified. In addition, the direction D1 of directivity of sound collection to be performed by the sound collection unit 10 does not have to match the long-length direction of the supporting member 131 as long as the direction D1 is a direction toward the front-side end of the sound collection unit 10.

On the other hand, FIG. 2 illustrates an example in the case where the supporting member 131 swings downward. In the example illustrated in FIG. 2, the supporting member 131 is supported such that the long-length direction of the supporting member 131 is toward a lower direction than the gaze direction of the user wearing the sound collection device 1 and the front-side end of the supporting member 131 is positioned near a mouth of the user. In the state illustrated in FIG. 2, the sound collection unit 10 is controlled such that voice of the user wearing the sound collection device 1 is mainly collected as a target sound on the basis of such a configuration.

The driver holder 30 is held by the wearable part 20 (to be described later) at a predetermined position with respect to an ear of the user wearing the sound collection device 1. The driver holder 30 includes a driver 31 therein.

The driver 31 includes a circuit or the like configured to perform various kinds of sound processes on sound signals. For example, the driver 31 acquires sound signals indicating sound collection results of the plurality of sound collection parts 111 from the sound collection unit 10, performs a sound process based on a so-called beamforming technology on the acquired sound signals, and then acquires a sound signal corresponding to a sound coming from the direction D1 (in other words, target sound). Next, the driver 31 outputs the sound (in other words, target sound) by driving a sound output part such as a so-called speaker on the basis of the acquired sound signal (in other words, a sound signal corresponding to the target sound). In the sound collection device 1 illustrated in FIG. 1 and FIG. 2, sound guide pipes 33 and 35 (to be described later) guides the sound output from the sound output part to a vicinity of an ear opening. This enables the user wearing the sound collection device 1 to hear the sound output from the sound output part.

The wearable part 20 is a structural element for mounting the sound collection device 1 on an ear of a user. Specifically, the wearable part 20 includes a long member that is configured to extend along a back side of an auricle in the case where the sound collection device 1 is worn on an ear of a user. By using such a structure, it is possible hook the wearable part 20 on an ear of a user and wear the sound collection device 1 on the ear.

In addition, the wearable part 20 supports the sound collection unit 10 and the driver holder 30. For example, in the example illustrated in FIG. 1, the sound collection unit 10 is supported near an end of the wearable part 20 positioned above the ear in the case where the sound collection device 1 is worn on the ear of the user. In addition, the driver holder 30 is supported by at least a portion of the long member of the wearable part 20. When the wearable part 20 is hooked on an ear of a user by using the above-described structure, the sound collection unit 10 and the driver holder 30 are supported by the wearable part 20 such that a predetermined positional relation is established between the ear and each of the sound collection unit 1 and the driver holder 30. In the case of using such a structure, the wearable part 20 preferably includes relatively hard material such as resin material, for example. Needless to say, the material of the wearable part 20 is not specifically limited as long as it is possible to support the sound collection unit 10 and the driver holder 30 such that the predetermined positional relation is established between the ear and each of the sound collection unit 10 and the driver holder 30.

In addition, a member positioned at a lower portion of an ear (member represented by the reference sign 201) of the long member of the wearable part 20 is worn such that the member 201 extends along a back side of an auricle toward the almost bottom direction and comes around an almost front side of an earlobe via a bottom portion of the earlobe. In addition, the member 201 has a so-called tube shape. The sound guide pipe 33 is provided in a space in the member 201. Note that, it is also possible for the tubular member 201 itself to function as the sound guide pipe 33.

In addition, a tubular member 203 is provided at an end of the member 201 positioned at the almost front side of the earlobe such that the tubular member 203 connects with the member 201. The tubular member 203 includes relatively soft material such as silicone. In addition, the sound guide pipe 35 is provided in the tubular member 203 such that the sound guide pipe 35 connects with the sound guide pipe 33. Note that, it is also possible for the tubular member 203 itself to function as the sound guide pipe 35.

The sound guide pipes 33 and 35 both have long tubular shapes, and provided such that they connects with each other. The sound guide pipes 33 and 35 that are connected with each other are supported by the tubular members 201 and 203 such that one end positions near the sound output part driven by the driver 31 (in other words, near the driver 31), and the other end positions near an auricle in the case where the sound collection device 1 is worn on an ear of a user. According to such a structure, it is possible for the sound guide pipes 33 and 35 to guide a sound output from the sound output part driven by the driver 31 to a vicinity of an ear opening of a user wearing the sound collection device 1, and it is possible for the user to hear the sound output from the sound output part.

Note that, in a way similar to the tubular member 203, the sound guide pipe 35 preferably includes relatively soft material such as silicone. According to such a structure, for example, it is possible to change shapes of the tubular member 203 and the sound guide pipe 35 to fit the shape of the ear of the user wearing the sound collection device 1, and it is possible to change the length of the tubular member 203 in a long-length direction by cutting a portion thereof.

The example of a schematic configuration of the sound collection device according to the embodiment of the present disclosure has been described with reference to FIG. 1 and FIG. 2.

### 1.2. Functional Configuration

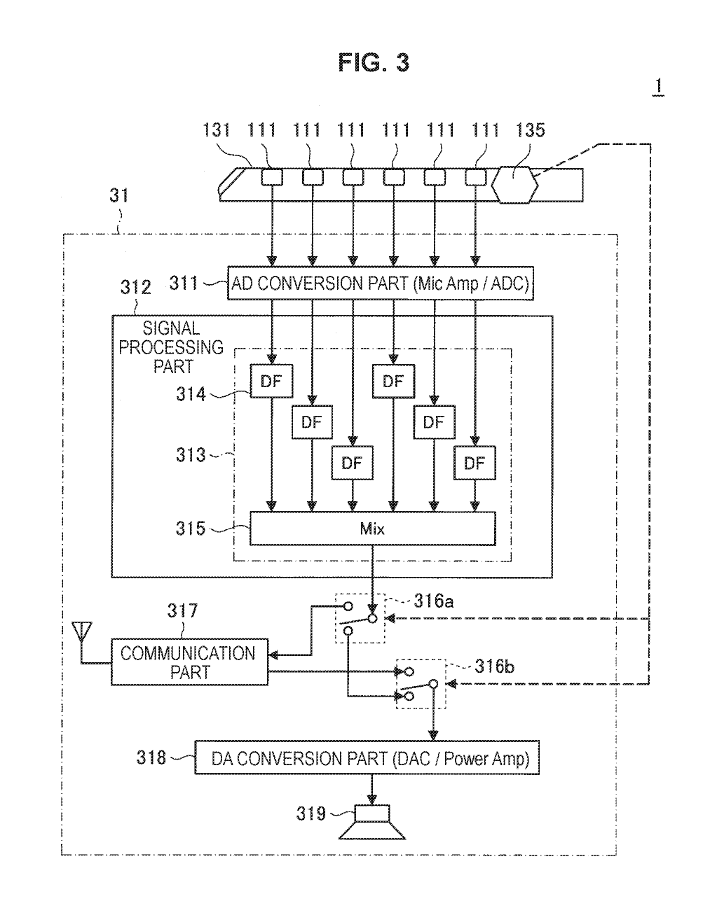

Next, with reference to FIG. 3, an example of a functional configuration of the sound collection device 1 according to the embodiment will be described while focusing on a configuration of the driver 31. FIG. 3 is a block diagram illustrating an example of a functional configuration of the sound collection device 1 according to the embodiment.

As illustrated in FIG. 3, the driver 31 includes an AD conversion part (microphone amplifier and AD converter (ADC)) 311, a signal processing part 312, switches 316a and 316b, a communication part 317, a DA conversion part (DA converter (DAC) and power amplifier) 318, and a sound output part 319.

The communication part 317 is a structural element configured to exchange information between the sound collection device 1 and an external device other than the sound collection device 1. As a specific example, the communication part 317 may include a baseband (BB) processor, an RF circuit, and the like, establish communication with another external device via a wireless communication path, and exchange information via the communication. In addition, as another example, the communication part 317 may include a connection terminal or the like for connecting a wired communication cable, and exchange information with the another external device by using communication via a wired communication path. By installing the communication part 317 as described above, it is possible to provide the sound collection device 1 with a function capable of talking on the phone with the another external device, for example.

Sound signals (hereinafter, also referred to as “input signals”) based on sound collection results of the respective sound collection parts 111 of the sound collection unit 10 are subjected to gain adjustment by the AD conversion part 311, and then converted from analog signals to digital signals. Next, the input signals converted into the digital signals are input to the signal processing part 312.

The signal processing part 312 is a structural element corresponding to a so-called digital signal processor (DSP). The signal processing part 312 acquires digital input signals based on the respective sound collection results of the plurality of sound collection parts 111 from the AD conversion part 311, and performs a so-called beamforming process on the input signals. Examples of the beamforming process include processes based on null control, minimum variance, maximum SNR, and independent component analysis, for example.

For example, the example of the functional configuration of the signal processing part 312 illustrated in FIG. 3 is an example in which a so-called Delay-and-Sum Beamforming is used as the beamforming process. In this case, the signal processing part 312 includes a plurality of digital filters (DFs) 314 and a mixer 315, for example. Note that, in the following description, a set of the plurality of digital filters 314 and the mixer 315 may be referred to as the signal processing unit 313.

Examples of the digital filters 314 include finite impulse response (FIR) filters, infinite impulse response (IIR) filters, and the like. In addition, the digital filters 314 may convert the input signals into frequency components by using a fast Fourier transform (FFT), and then perform the filtering process on the input signals in a frequency domain. The input signals based on the sound collection results of the respective sound collection parts 111 are subjected to the filtering process by the digital filters 314, and combined by the mixer 315. Subsequently, a sound signal acquired as a result of the combining is input into one of terminals of the switch 316a. Note that, the beamforming process based on the Delay-and-Sum Beamforming is widely known. Therefore, detailed description thereof will be omitted. In addition, as described above, it is possible to acquire a sound signal based on a sound (in other words, target sound) coming from the direction D1 illustrated in FIG. 1 with a high S/N ratio, by performing the beamforming process on the input signals based on the sound collection result of the respective sound collection parts 111, for example. Note that, in this case, it is also possible for the signal processing part 312 to suppress sounds coming from the rear side of the user (rear-side end of the sound collection unit 10).

The DA conversion part 318 converts the input digital sound signal into an analog sound signal, performs the gain adjustment on the analog sound signal, and output it to the sound output part 319. For example, the sound output part 319 includes an audio device such as a speaker. The sound output part 319 is driven on the basis of the sound signal output from the DA conversion part 318 and then output a sound based on the sound signal. Note that, for example, the sound guide pipes 33 and 35 illustrated in FIG. 1 and FIG. 2 guide the sound output from the sound output part 319 to a vicinity of an ear opening of a user wearing the sound collection device 1.

The switches 316a and 316b switch relations of connection between the signal processing part 312, the communication part 317, and the DA conversion part 318 on the basis of a control signal output from the sound collection unit 10 in accordance with a state of the rotation part 135 of the sound collection unit 10.

As a specific example, in the case where the rotation part 135 rotates upward and the direction D1 of directivity of the sound collection unit 10 substantially matches the gaze direction of the user as illustrated in FIG. 1, the signal processing part 312 and the DA conversion part 318 are connected via the switches 316a and 316b. In this case, a sound signal output from the signal processing part 312 (in other words, sound signal subjected to the beamforming process) is converted from a digital sound signal to an analog sound signal by the DA conversion part 318, subjected to the gain adjustment, and then drives the sound output part 319. Accordingly, it is possible for the user to hear a sound based on a sound collection result of the sound collection unit 10 (for example, target sound coming from the direction D1 illustrated in FIG. 1).

Alternatively, as another example, in the case where the rotation part 135 rotates downward and the front-side end of the supporting member 131 is positioned near the mouth of the user as illustrated in FIG. 2, the signal processing part 312 and the communication part 317 are connected via the switch 316a. In addition, in this case, the communication part 317 and the DA conversion part 318 are connected via the switch 316b. In this case, the sound signal output from the signal processing part 312 is transmitted to the external device via the communication part 317. In other words, a sound signal based on a sound collection result of voice of the user wearing the sound collection device 1 is transmitted to the external device via the communication part 317 (in other words, voice transmission). In addition, a sound signal transmitted from the external device is received by the communication part 317, and output from the communication part 317 to the DA conversion part 318 via the switch 316b. In this case, the sound signal output from the communication part 317 (in other words, sound signal transmitted from the external device) is converted from a digital sound signal to an analog sound signal by the DA conversion part 318, subjected to the gain adjustment, and then drives the sound output part 319. Accordingly, it is possible for the user to hear a sound based on the sound signal transmitted from the external device (in other words, voice reception).

With reference to FIG. 3, the example of the functional configuration of the sound collection device 1 according to the embodiment has been described above while focusing on the configuration of the driver 31. Note that, the above-described functional configuration of the sound collection device 1 is merely an example, and the present disclosure is not limited thereto. As a specific example, other structural elements may be added in accordance with the functions of the sound collection device 1. In addition, at least some of the structural elements of the driver 31 may be installed in the outside of the driver 31 (such as the sound collection unit 10 or another device).

### 1.3. Effect

As described above, in the sound collection device 1 according to the embodiment, the sound collection unit 10 includes the plurality of sound collection parts 111 supported at different positions along the long-length direction (in other words, extending direction) of the supporting member 131. According to such a structure, it is possible for the respective sound collection parts 111 to collects sounds at different timings especially in the case where sounds come from the long-length direction of the supporting member 131. In other words, with regard to collection of sounds coming from the long-length direction of the supporting member 131, the sound collection device 1 according to the embodiment is capable of controlling directivity with high accuracy on the basis of the so-called beamforming technology while using the simple structure and preventing the device from getting larger or complex. In other words, by using the sound collection device 1 according to the embodiment, it is possible to acquire target sounds in a preferred manner while preventing the device from getting larger.

### 2. MODIFICATIONS

Next, modifications of the sound collection device 1 according to the embodiment will be described.

### 2.1. First Modification: Example of Configuration Related to Output of Sound Collection Result

First, as a first modification, an example of a configuration related to output of a sound collection result of the sound collection unit 10 will be described. Specifically, in the example described with reference to FIG. 1 and FIG. 2, the driver 31 of the sound collection device 1 drives the sound output part 319 in accordance with sound signals based on a sound collection result of the sound collection unit 10, and the sound guide pipes 33 and 35 guides sounds output from the sound output part 319 to a vicinity of an ear opening of a user. However, the configuration related to the output of the sounds is not limited to the example illustrated in FIG. 1 and FIG. 2 as long as the user is capable of directly or indirectly hearing or recognizing the sounds based on the sound collection result of the sound collection unit 10.

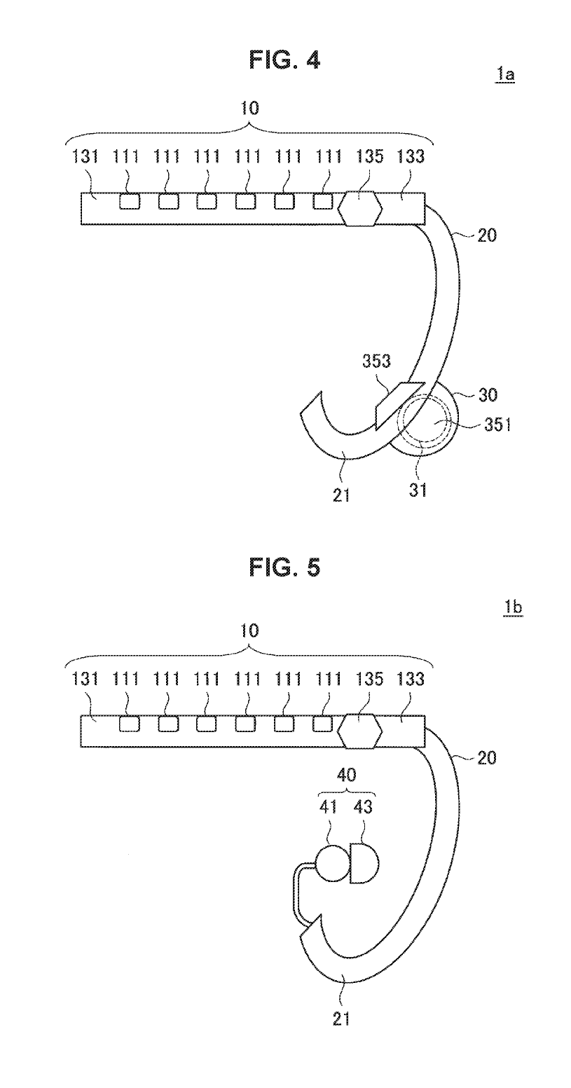

For example, FIG. 4 is an explanatory diagram illustrating an example of a schematic configuration of a sound collection device according to the first modification. FIG. 4 illustrates an example in which a user recognizes sounds based on a sound collection result of the sound collection unit 10 through so-called bone conduction. Note that, to distinguish the sound collection device illustrated in FIG. 4 from the other sound collection devices, sometimes the sound collection device illustrated in FIG. 4 will be referred to as a “sound collection device 1a” in the following description.

As illustrated in FIG. 4, for example, the driver 31 of the sound collection device 1a drives a vibration part 351 such as a piezoelectric vibration element by using a sound signal based on a sound collection result of the sound collection unit 10 instead of the sound output part 319 such as a speaker. In addition, a vibration transfer part 353 is a structural element for transferring vibration of the vibration part 351. At least a portion of a long member of the wearable part 20 supports the vibration transfer part 353 such that the vibration transfer part 353 is in contact with at least a portion of a head of a user wearing the sound collection device la (such as a mastoid process positioned at a back side of an auricle). According to such a structure, it is possible to transfer vibration of the vibration part 351 driven by the sound signal based on the sound collection result of the sound collection unit 10 to at least a portion of a head of a user via the vibration transfer part 353, for example, and it is possible for the user to recognize the sound collection result of the sound collection unit 10.

Note that, in the case of the example illustrated in FIG. 4, it is not necessary to provide the sound guide pipe 33 or 35 unlike the example illustrated in FIG. 1 or FIG. 2. Therefore, the sound collection device la illustrated in FIG. 4 includes a guide member 21 instead of the tubular member 201 illustrated in FIG. 1 and FIG. 2, for example. The guide member 21 is configured to fix the sound collection device 1a on an ear of a user.

In addition, FIG. 5 is an explanatory diagram illustrating another example of a schematic configuration of a sound collection device according to the first modification. FIG. 4 illustrates an example in which a so-called in-ear earphone is used as a structural element for outputting sounds based on a sound collection result of the sound collection unit 10. Note that, to distinguish the sound collection device illustrated in FIG. 5 from the other sound collection devices, sometimes the sound collection device illustrated in FIG. 5 will be referred to as a “sound collection device 1b” in the following description.

As illustrated in FIG. 5, the sound collection device 1b includes an earphone part 40 instead of the driver 31 illustrated in FIG. 1 and FIG. 2. The earphone part 40 includes a driver 41 and a wearable part 43. The driver 41 is a structural element corresponding to the driver 31 of the sound collection device 1 illustrated in FIG. 1 and FIG. 2. The wearable part 43 has a shape that allows the wearable part 43 to be inserted into an ear opening of a user. When the wearable part 43 is inserted into the ear opening, the earphone part 40 is worn in the ear of the user. According to such a configuration, the driver 41 drives the sound output part such as a speaker on the basis of a sound signal based on a sound collection result of the sound collection unit 10, for example, and then a sound output from the sound output part is output to the inside of the ear opening of the user via the wearable part 43. This enables the user to hear a sound based on a sound collection result of the sound collection unit 10.

As the first modification, the examples of the configuration related to output of a sound collection result of the sound collection unit 10 have been described above with reference to FIG. 4 and FIG. 5.

### 2.2. Second Modification: Example of Configuration of Sound Collection Unit

Next, as a second modification, an example of a configuration of the sound collection unit 10 will be described. As described above, the supporting member 131 of the sound collection unit 10 according to the embodiment has the long shape and supports the plurality of sound collection parts 111 at respective positions different from each other along the long-length direction. According to such a configuration, it is possible for the sound collection unit 10 according to the embodiment to acquire sounds coming from the long-length direction of the supporting member 131 in a preferred manner on the basis of the so-called beamforming technology.

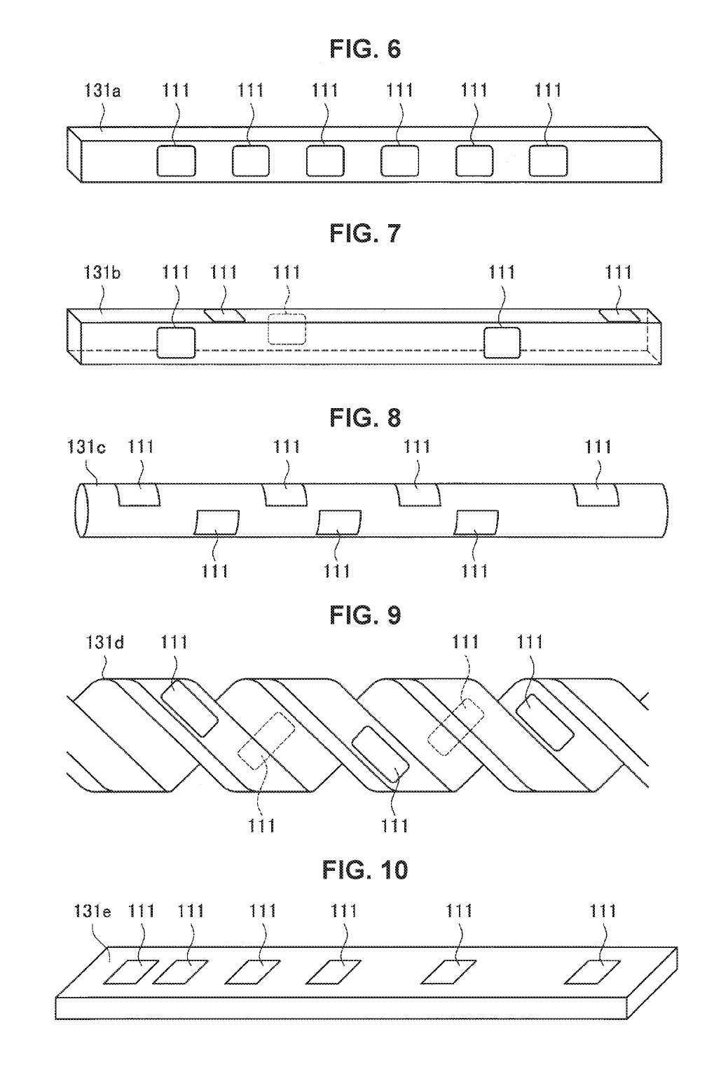

However, the configuration of the sound collection unit 10 (specifically, shape of the supporting part 131 or arrangement of the respective sound collection parts 111) is not specifically limited as long as the supporting member 131 has a long shape and supports the plurality of sound collection parts 111 at respective positions different from each other along the long-length direction of the supporting member 131. For example, FIG. 6 to FIG. 10 are explanatory diagrams illustrating examples of configurations of the sound collection unit 10 according to the second modification. Note that, to illustrate characteristic portions in a more understandable way, each of FIG. 6 to FIG. 10 illustrates a supporting member 131 and a plurality of sound collection parts 111 while focusing on their configurations, and omits the other structural elements of the sound collection unit 10.

First, examples illustrated in FIG. 6 and FIG. 7 will be described. Note that, to distinguish the supporting member 131 illustrated in FIG. 6 from supporting members 131 according to the other examples, sometimes the supporting member 131 illustrated in FIG. 6 will be referred to as a “supporting member 131a” in the following description. In a similar way, to distinguish the supporting member 131 illustrated in FIG. 7 from supporting members 131 according to the other examples, sometimes the supporting member 131 illustrated in FIG. 7 will be referred to as a “supporting member 131b” in the following description.

In the example illustrated in FIG. 6, the plurality of sound collection parts 111 are supported at different positions along the long-length direction of the supporting member 131a on only one of the faces of the supporting member 131a having a prismatic shape. In addition, the supporting member 131b according to the example illustrated in FIG. 7 also has a prismatic shape like the supporting member 131a illustrated in FIG. 6. However, in the example illustrated in FIG. 7, the plurality of sound collection parts 111 are supported at different positions along the long-length direction of the supporting member 131b not only on one of the faces of the supporting member 131b but also on respective faces of the supporting member 131b. As described above, the positions at which the respective sound collection parts 111 are supported are not limited as long as a condition that the plurality of sound collection parts 111 are supported at different positions along the long-length direction of the supporting member 131 is satisfied.

Next, the example illustrated in FIG. 8 will be described. Note that, to distinguish the supporting member 131 illustrated in FIG. 8 from supporting members 131 according to the other examples, sometimes the supporting member 131 illustrated in FIG. 8 will be referred to as a “supporting member 131c” in the following description. In the example illustrated in FIG. 8, the plurality of sound collection parts 111 are supported at different positions along the long-length direction of the supporting member 131c on a face of the supporting member 131c. The supporting member 131c has a cylindrical shape. As described above, the shape of the supporting member 131 is not limited as long as a conditions that the supporting member 131 has a long shape and the plurality of sound collection parts 111 are supported at different positions along the long-length direction of the supporting member 131 is satisfied.

Next, the example illustrated in FIG. 9 will be described. Note that, to distinguish the supporting member 131 illustrated in FIG. 9 from supporting members 131 according to the other examples, sometimes the supporting member 131 illustrated in FIG. 9 will be referred to as a “supporting member 131d” in the following description. In the example illustrated in FIG. 9, the long supporting member 131d is twisted like a helix. The plurality of sound collection parts 111 are provided in an extending direction of the supporting member 131d. In this case, the plurality of sound collection parts 111 are supported at different positions along the long-length direction of the supporting member 131 twisted like the helix.

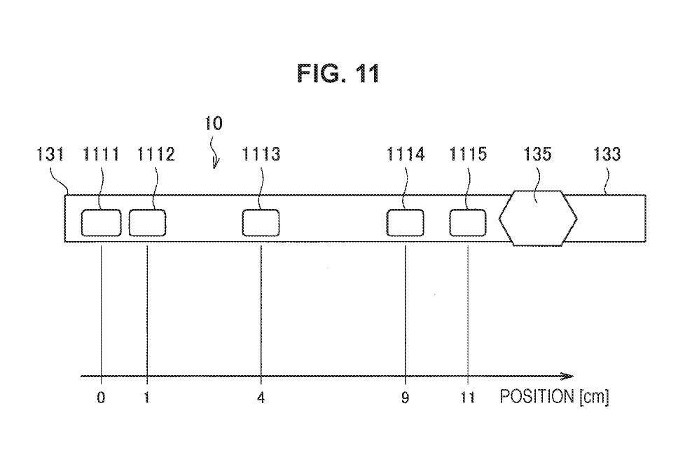

Next, the example illustrated in FIG. 10 will be described. Note that, to distinguish the supporting member 131 illustrated in FIG. 10 from supporting members 131 according to the other examples, sometimes the supporting member 131 illustrated in FIG. 10 will be referred to as a “supporting member 131e” in the following description. In the example illustrated in FIG. 10, the supporting member 131e has a long plate-like shape. The plurality of sound collection parts 111 are supported at different positions along the long-length direction of the supporting member 131e on a face of the supporting member 131e.

As described above, the configuration (such as a shape of the supporting member 131 and positions at which the respective sound collection parts are supported) of the sound collection unit 10 according to the embodiment is not specifically limited as long as conditions that the supporting member 131 has a long shape and the plurality of sound collection parts 111 are supported at different positions along the long-length direction of the supporting member 131 are satisfied.

As the second modification, the examples of the configurations of the sound collection unit 10 have been described above with reference to FIG. 6 and FIG. 10.

### 2.3. Third Modification: Example of Arrangement of Sound Collection Parts

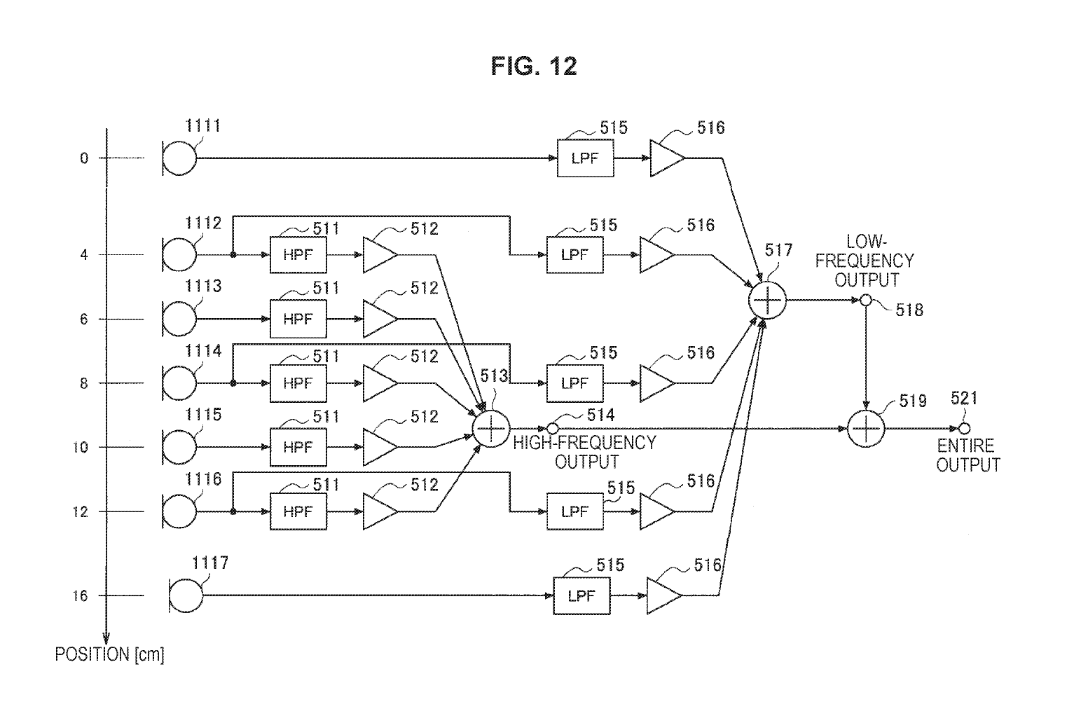

Next, with reference to FIG. 11 and FIG. 12, an example of arrangement of the respective sound collection parts 111 of the sound collection unit 10 will be described as a third modification, while focusing on intervals between the respective sound collection parts 111 along the long-length direction of the supporting member 131. FIG. 11 and FIG. 12 are explanatory diagrams illustrating an overview of the sound collection unit 10 according to the third modification.

As described above, in the sound collection unit 10 according to the embodiment, positions at which the respective sound collection parts 111 are arranged and intervals between the sound collection parts 111 are not specifically limited as long as the supporting member 131 has a long shape and the plurality of sound collection parts 111 are supported at different positions along the long-length direction of the supporting member 131. On the other hand, sometimes it may be possible to acquire a target sound in a preferred manner (for example, with a high S/N ratio) when the intervals between the respective sound collection parts 111 are adjusted depending on usage of the sound collection device 1 (in other words, a sound set as the target sound).

For example, FIG. 11 is an example in which the plurality of sound collection parts 111 are arranged such that the intervals between the respective sound collection parts 111 along the long-length direction of the supporting member 131 becomes unequal to each other. Note that, in the example illustrated in FIG. 11, the plurality of sound collection parts 111 are arranged on the assumption that the rotation part 135 is rotated such that the front-side end of the sound collection unit 10 is positioned near the mouth of the user and voice of the user is collected, like the example illustrated in FIG. 2.

In the example illustrated in FIG. 11, the five sound collection parts 111 are supported by the supporting member 131 of the sound collection unit 10. Note that, in the present specification, sometimes the respective sound collection parts 111 may be referred to as sound collection parts 1111 to 1115 from the front-side end of the of the supporting member 131 as illustrated in FIG. 11, to distinguish the five sound collection parts 111 from each other.

As illustrated in FIG. 11, the sound collection part 1112 is supported at a position 1 cm away from the sound collection part 1111 in the long-length direction of the supporting member 131. In a similar way, the sound collection part 1113 is supported at a position 4 cm away from the sound collection part 1111 in the long-length direction of the supporting member 131. In addition, the sound collection part 1114 is supported at a position 9 cm away from the sound collection part 1111 in the long-length direction of the supporting member 131, and the sound collection part 1115 is supported at a position 11 cm away from the sound collection part 1111 in the long-length direction of the supporting member 131.

Such a structure enables selection from different variations of intervals between two sound collection parts 111 in accordance with combinations for selecting two sound collection parts 111 from the sound collection parts 1111 to 1115. As a specific example, when selecting the sound collection parts 1111 and 1113 as the two sound collection parts 111, a distance between the two sound collection parts 111 is 4 cm. In addition, as another example, when selecting the sound collection parts 1112 and 1115 as the two sound collection parts 111, a distance between the two sound collection parts 111 is 10 cm. Therefore, according to the example illustrated in FIG. 11, it is possible to make a selection from 10 patterns other than a case in which the distance becomes 6 cm, as the variations of the distance between two sound collection parts 111 when considering the distance between two sound collection parts 111 with 1 cm increments from 1 cm to 11 cm. As described above, since it is possible to make a selection from different variations as the distance between the two sound collection parts 111, it is possible to suppress side lobes (in other words, emphasis on a sound from an unintended direction) in a sound analysis process more easily, for example.

In addition, in the example illustrated in FIG. 11, an interval between the sound collection parts 1111 and 1112 is set to about 1 cm. The sound collection parts 1111 and 1112 are on the front side of the supporting member 131 and positioned near the mouth of the user wearing the sound collection device 1. Such a structure enables the sound collection device 1 to easily discriminate voice of the user wearing the sound collection device 1 from voice of the other people. Specifically, voice of the user wearing the sound collection device 1 tends to have relatively large difference in sound collection result level between the sound collection parts 1111 and 1112. On the other hand, voice of the other people (especially, a person about 1 m or more away from the sound collection device 1) tends to have smaller difference in sound collection result level between the sound collection parts 1111 and 1112 than the voice of the user wearing the sound collection device 1. By using such characteristics, it is possible for the sound collection device 1 to more easily determine whether voice collected by the sound collection unit 10 is voice of the user wearing the sound collection device 1 or voice of another person.

In addition, in the example illustrated in FIG. 11, an interval between the sound collection parts 1114 and 1115 is set to about 2 cm. The sound collection parts 1114 and 1115 are on the rear side of the supporting member 131 and positioned near a tip of the sound collection device 35 that outputs a sound in the example illustrated in FIG. 2 (in other words, near an ear of the user wearing the sound collection device 1). Such a structure enables suppression of occurrence of spatial aliasing also in a high frequency (such as 8 kHz) in which audio feedback occurs, when beamforming is used to suppress a sound signal of a sound that is output from the sound guide pipe 35 and collected by the respective sound collection parts 111 (in other words, the sound serving as a cause of audio feedback), for example.

Next, the example illustrated in FIG. 12 will be described. FIG. 12 illustrates an example of a functional configuration of the sound collection unit 10 related to sound collection in the case of collecting sound while dividing the sound into a high-frequency sound and a low-frequency sound. In the example illustrated in FIG. 12, the sound collection unit 10 includes sound collection parts 1111 to 1117 as the plurality of sound collection parts 111. More specifically, the sound collection unit 10 includes the sound collection parts 1111 to 1117, low-pass filters (LPFs) 515, high-pass filters (HPFs) 517, amplifiers 512 and 516, adders 513, 517, and 519. In addition, the sound collection parts 1111 to 1117 are supported by the supporting member 131 in this order from the front-side end of the supporting member 131 to the rear-side end of the supporting member 131. Note that, an index illustrated in the left side of the sound collection parts 1111 to 1117 in FIG. 12 represents positions along the long-length direction of the supporting member 131 while using a position at which the sound collection part 1111 is supported as a criterion (in other words, 0 cm).

In the example illustrated in FIG. 12, the respective sound collection parts 1111, 1112, 1114, 1116, and 11117 are supported at intervals of 4 cm along the long-length direction of the supporting member 131. In addition, the respective sound collection parts 1112 to 1116 are supported at intervals of 2 cm along the long-length direction of the supporting member 131.

Via the LPFs 515, low-frequency components are extracted from sound signals based on sound collection results of the sound collection parts 1111 and 1117, and the low-frequency components are input to the amplifiers 516. Next, the low-frequency components are subjected to gain adjustment by the amplifiers 516, and input to the adder 517.

Alternatively, via the HPFs 511, high-frequency components are extracted from sound signals based on sound collection results of the sound collection parts 1113 and 1115, and the high-frequency components are input to the amplifiers 512. Next, the high-frequency components are subjected to gain adjustment by the amplifiers 512, and input to the adder 513.

On the other hand, sound signals based on sound collection results of the sound collection parts 1112, 1114, and 1116 are split by splitters or the like. One of each split sound signal is input to an HPF 511, and the other of the each split sound signal is input to an LPF 515. Via the HPFs 511, high-frequency components are extracted from the sound signals input to the HPFs 511, and the high-frequency components are input to the amplifiers 512. Next, the high-frequency components are subjected to gain adjustment by the amplifiers 512, and input to the adder 513. Alternatively, via the LPFs 515, low-frequency components are extracted from the sound signals input to the LPFs 515, and the low-frequency components are input to the amplifiers 515. Next, the low-frequency components are subjected to gain adjustment by the amplifiers 516, and input to the adder 517.

The adder 517 adds low-frequency components extracted via the LPFs 515 from the respective sound signals based on the sound collection results of the sound collection parts 1111, 1112, 1114, 1116, and 11117. Accordingly, a terminal 518 outputs sound collection results of the low-frequency components (hereinafter, also referred to as “low-frequency output”) among the sound collection results of the sound collection unit 10. In a similar way, the adder 513 adds high-frequency components extracted via the HPFs 511 from the respective sound signals based on the sound collection results of the sound collection parts 1112 to 1116. Accordingly, a terminal 514 outputs sound collection results of the high-frequency components (hereinafter, also referred to as “high-frequency output”) among the sound collection results of the sound collection unit 10.

In other words, in the example illustrated in FIG. 12, the low-frequency output is acquired on the basis of the sound collection results of the sound collection parts 1111, 1112, 1114, 1116, and 11117 supported at the intervals of 4 cm, and the high-frequency output is acquired on the basis of the sound collection results of the sound collection parts 1112 to 1116 supported at the intervals of 2 cm. Next, the adder 519 adds the low-frequency output that is output to the terminal 518 and the high-frequency output that is output to the terminal 514, and the addition result is output to a terminal 521 as entire output.

Here, a configuration and a process for general beamforming using a so-called microphone array will be described. In general, to prevent the spatial aliasing in a high frequency, sound collection parts (microphones, or the like) tend to be arranged at narrow intervals. On the other hand, to acquire sharp directivity, the array size (in other words, the entire length of the microphone array) tends to get longer. Therefore, to achieve both prevention of spatial aliasing and acquisition of sharp directivity, the number of sound collection parts tends to increase and an amount of computation for the beamforming also tends to increase in general.

On the other hand, according to the third modification of the embodiment, the sound collection unit 10 having the configuration illustrated in FIG. 12 has different intervals between the sound collection parts 111 used for sound collection, with regard to high-frequency sounds and low-frequency sounds. According to such a configuration, it is possible for the sound collection unit 10 illustrated in FIG. 12 to suppress increase in the number of microphones and the amount of computation for beamforming, thereby collecting a target sound in a preferred manner.

With reference to FIG. 11 and FIG. 12, the examples of arrangement of the respective sound collection parts 111 of the sound collection unit 10 have been described as the third modification, while focusing on intervals between the respective sound collection parts 111 along the long-length direction of the supporting member 131.

### 2.4. Fourth Modification: Example of Removable Sound Collection Unit

Next, an example of a sound collection unit 10 configured to be removable from an external device including the driver 31 (also referred to as a “removable sound collection unit 10”) will be described as a fourth modification.

### Example of Functional Configuration

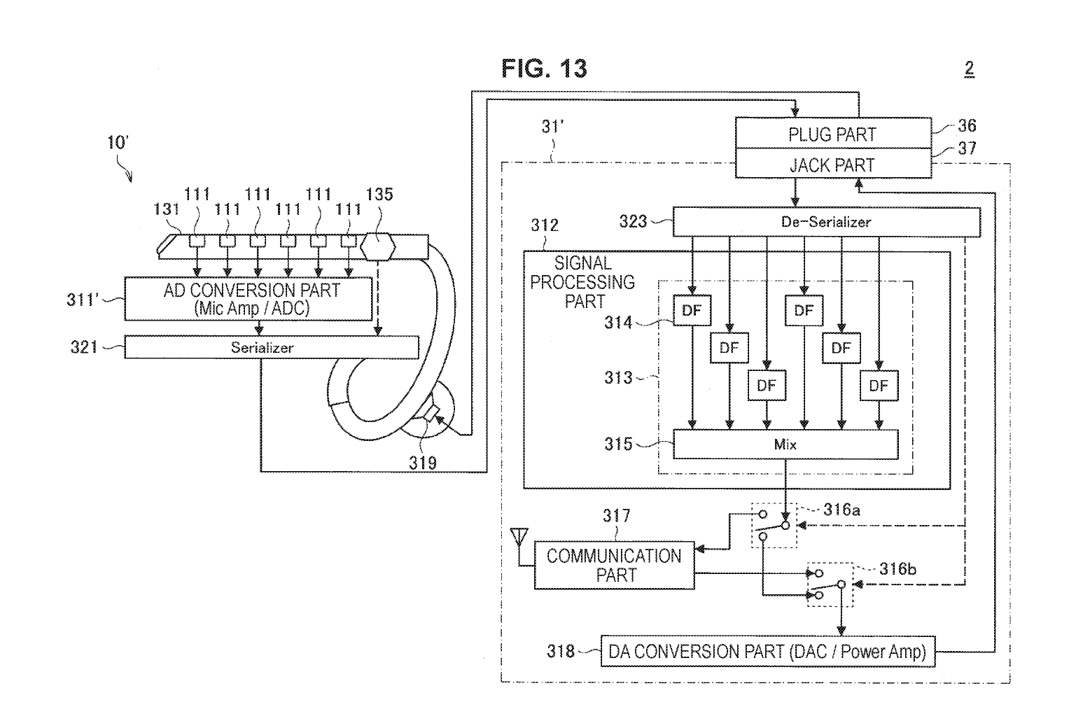

First, with reference to FIG. 13, an example of a functional configuration of a sound collection system 2 including a sound collection unit 10 according to the fourth modification will be described. FIG. 13 is an explanatory diagram illustrating an example of the sound collection system 2 including the sound collection unit 10 according to the fourth modification. FIG. 13 illustrates an example of functional configurations of the sound collection unit 10 and the driver 31. The sound collection unit 10 is configured to be removable from an external device, and the driver 31 is installed on the external device side. Note that, to distinguish the removable sound collection unit 10 such as the sound collection unit 10 according to the fourth modification from the other sound collection units, sometimes the removable sound collection unit 10 will be referred to as a “sound collection unit 10′”. In a similar way, to distinguish the driver 31 that is installed in the external device such as the driver 31 according to the fourth modification from the other drivers 31, sometimes the driver 31 installed in the external device will be referred to as a “driver 31′”.

As illustrated in FIG. 13, in the sound collection system 2, the sound collection unit 10′ and the driver 31′ installed on the external device side are electrically connected via a plug part 36 and a jack part 37. The plug part 36 is installed on the sound collection unit 10′ side, and the jack part 37 is installed in the driver 31′.

The sound collection unit 10′ includes an AD conversion part (microphone amplifier and AD converter (ADC)) 311′ and a serializer 321. In addition, in the example illustrated in FIG. 13, the sound output part 319 is installed on the sound collection unit 10′ side.

Sound signals indicating sound collection results of the respective sound collection parts 111 (in other words, input signals) are subjected to gain adjustment, converted from analog signals to digital signals via the AD conversion part 311′, and input to the serializer 321. In addition, a control signal corresponding to a state of the rotation part 135 is also input to the serializer 321. Next, the serializer 321 superimposes (in other words, serializes) the control signal corresponding to the state of the rotation part 135 on the respective input signals corresponding to the sound collection parts 111. The input signals have been converted into digital signals. Subsequently, the superimposed signals are input to the driver 31′ via the plug part 36 and the jack part 37.

The driver 31′ includes a de-serializer 323. The de-serializer 323 brakes down the signals superimposed by the serializer 321 into the control signal corresponding to the state of the rotation part 135 and the respective input signal corresponding to the sound collection parts 111. Next, the respective input signals corresponding to the sound collection parts 111 are input into the signal processing part 312, and the control signal corresponding to the state of the rotation part 135 is input to the switches 316a and 316b.

Note that, respective processes performed by the signal processing part 312, the switches 316 and 316b, the communication part 317, and the DA conversion part 318 in the driver 31′ are similar to those of the driver 31 described with reference to FIG. 3. Therefore, detailed descriptions thereof are omitted here. Next, the sound signal output from the DA conversion part 318 is output to the sound output part 319 via the jack part 37 and the plug part 36, and the sound signal drives the sound output part 319. The sound output part 319 is installed on the sound collection unit 10′ side.

Note that, the above-described functional configuration of the sound collection system 2 illustrated in FIG. 13 is merely an example, and the present disclosure is not limited thereto. As a specific example, it may be possible to install the sound output part 319 on the external device side including the driver 31′. In addition, as another example, at least some of the structural elements of the driver 31′ may be installed on the sound collection unit 10′ side. As a specific example, it is possible to install the DA conversion part 318 on the sound collection unit 10′ side. In this case, it is only necessary to output the sound signal from the switch 316b to the DA conversion part 318 installed on the sound collection unit 10′ side, via the jack part 37 and the plug part 36.

With reference to FIG. 13, the example of the functional configuration of the sound collection system 1′ including the sound collection unit 10 according to the fourth modification has been described above.

### First Implementation Example of Removable Sound Collection Unit

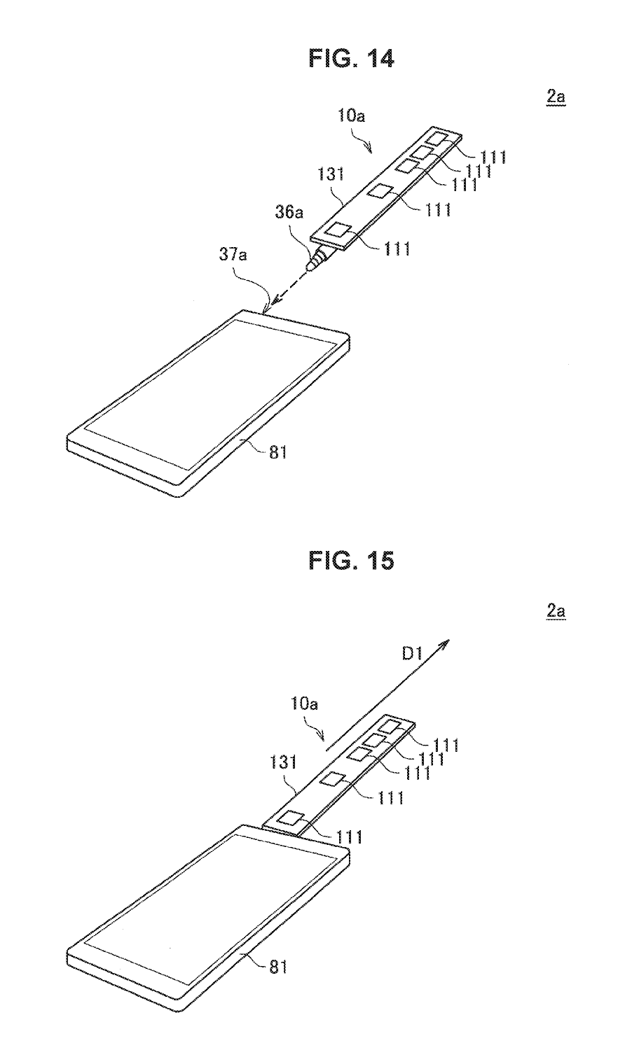

Next, an implementation example of the removable sound collection unit 10′ according to the fourth modification will be described. For example, FIG. 14 and FIG. 15 are explanatory diagrams illustrating an example of the removable sound collection unit 10′ according to the fourth modification. Note that, to distinguish the sound collection unit 10′ illustrated in FIG. 14 and FIG. 15 from the other sound collection units, sometimes the sound collection units 10′ illustrated in FIG. 14 and FIG. 15 will be referred to as a “sound collection unit 10a” in the following description.

As illustrated in FIG. 14, a sound collection system 2a includes the sound collection unit 10a and an external device 81. The external device 81 is a device including a structural element corresponding to the driver 31′ illustrated in FIG. 13. For example, the external device 81 may be an information processing device such as a smartphone. The sound collection unit 10a includes the plurality of sound collection parts 111, the supporting member 131, and a plug part 36a. The supporting member 131 has a long plate-like shape, and the plug part 36a is configured to connect with the external device 81. The supporting member 131 supports the plurality of sound collection parts 111 at different positions along the long-length direction.

In addition, the plug part 36a is configured as a 3.5 mm plug interface including a multi-pole terminal (for example, about 3 to 5 poles). The plug part 36a is inserted into a jack part 37a (such as a headphone jack) of the external device 81 such that the sound collection unit 10a and the external device 81 are connected. For example, FIG. 15 illustrates a situation in which the external device 81 and the sound collection unit 10a are connected. As illustrated in FIG. 15, in the sound collection system 2a, the directivity of the sound collection unit 10a is toward the long-length direction of the supporting member 131 indicated by the reference sign D1.

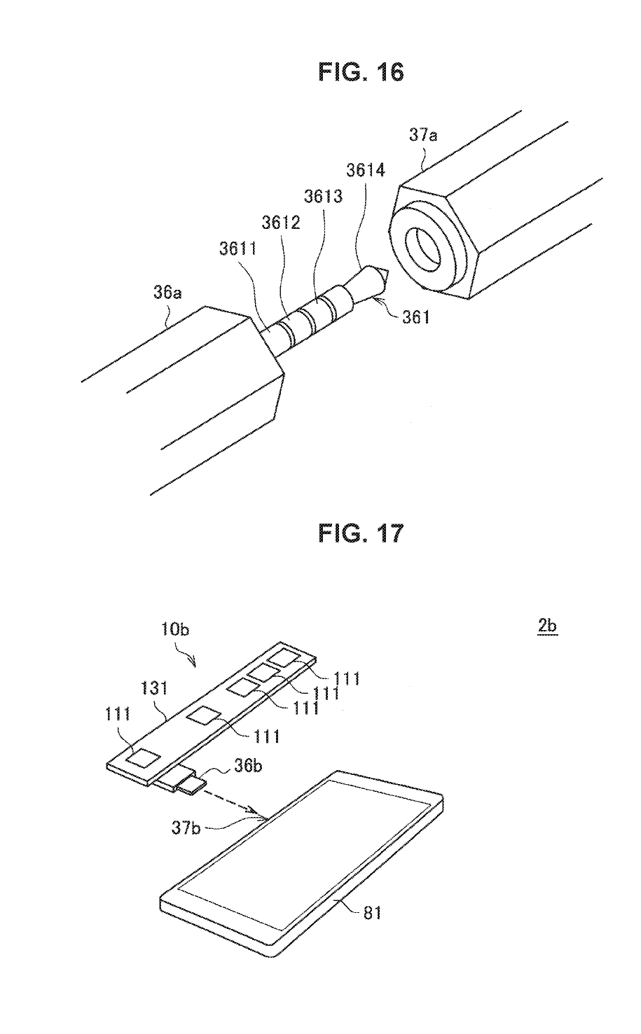

Here, with reference to FIG. 16, an example of schematic configurations of the plug part 36a and the jack part 37a will be described. FIG. 16 is an explanatory diagram illustrating the example of the schematic configurations of the plug part 36a and the jack part 37a. FIG. 16 illustrates an example in which the plug part 36a is configured as a 3.5 mm 5-pole plug interface.

As illustrated in FIG. 16, the plug part 36a includes a cylindrical plug 361 (in other words, 3.5 mm plug interface). The plug 361 is electrically separated into a plurality of terminals 3611 to 3615 along the long-length direction. In the case where the plug part 36a is connected with the jack part 37a, the respective terminals 3611 to 3615 of the plug 361 are electrically connected with different terminals in the jack part 37a. According to such a configuration, it is possible for the sound collection unit 10a to perform different types of communication (such as serial communication) via the respective terminals 3611 to 3615 different from each other. Examples of the different types of communication include transmission of information to the external device 81, reception of information from the external device 81, supply of electric power from the external device 81, and the like. In addition, it is possible for the sound collection unit 10a to include a storage part. The storage part may store information indicating respective acoustic characteristics (such as sensitivity) of the plurality of sound collection parts 111. In such a case, the sound collection unit 10a may use at least one of the terminals 3611 to 3615 of the plug 361 to notify the external device 81 of the information indicating the respective acoustic characteristics of the plurality of sound collection parts 111, for example. This enables the external device 81 to perform a signal process for reducing variation in accordance with the respective acoustic characteristics of the plurality of sound collection parts 111, or a signal process corresponding to arrangement of the respective sound collection parts 111, for example.

Note that, it is also possible to install the plug part 36a at the front-side end of the supporting member 131 such that the sound collection unit 10a becomes capable of connecting with another sound collection unit 10a. According to such a configuration, it is possible to connect a plurality of sound collection units 10a along the long-length direction of the supporting member 131, for example. This enables to increase the number of sound collection parts 111 and improve directivity of sound collection (especially directivity to the direction D1) more. Note that, in the case where the plurality of sound collection units 10a are connected, one sound collection unit 10a may notify the driver 31′ in the external device 81 of information indicating a connection state of the other sound collection unit 10a via the plug part 36a and the jack part 37a. According to such a configuration, the driver 31′ in the external device 81 may recognize connection states of the plurality of sound collection units 10a and recognize a positional relation between the respective sound collection parts 111 of the plurality of sound collection units 10a in accordance with the recognition result.

In addition, in the sound collection system 2 illustrated in FIG. 14 and FIG. 15, the sound output part for outputting sound collection results of the sound collection unit 10a is not specifically limited. For example, it is possible for the sound collection unit 10a itself to include the sound output part. Alternatively, as another example, the sound output part (such as a speaker) of the external device 81 may be used for outputting sound collection results of the sound collection unit 10a.

In addition, the interface for connecting the sound collection unit 10′ with the external device 81 is not limited to the plug part 36a or the jack part 37a illustrated in FIG. 16 (in other words, 3.5 mm plug interface).

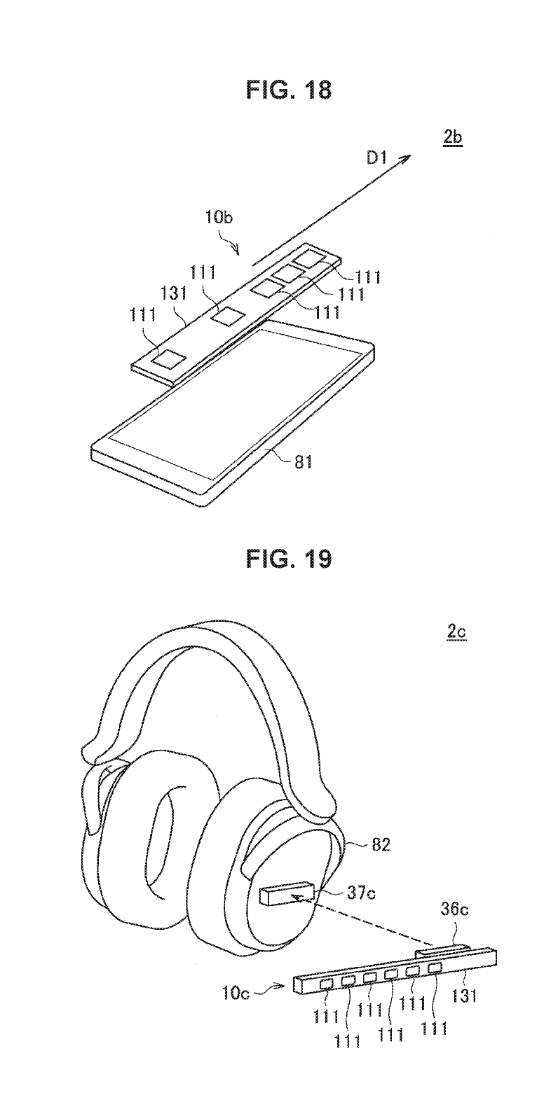

For example, FIG. 17 and FIG. 18 are explanatory diagrams illustrating another example of the removable sound collection unit 10′ according to the fourth modification. FIG. 17 and FIG. 18 illustrate an example in which an existing interface such as Universal Serial Bus (USB) is used as the interface for connecting the sound collection unit 10′ with the external device 81. Note that, to distinguish the sound collection unit 10′ illustrated in FIG. 14 and FIG. 15 from the other sound collection units, sometimes the sound collection unit 10′ illustrated in FIG. 14 and FIG. 15 will be referred to as a “sound collection unit 10b” in the following description.

As illustrated in FIG. 17, although a sound collection system 2b includes an interface configured to connect the sound collection unit 10b with the external device 81, the interface is different from that of the sound collection system 2a illustrated in FIG. 14 and FIG. 15. However, the other structural elements of the sound collection system 2b are similar to those of the sound collection system 2a. Therefore, description is provided here while focusing on the interface for connecting the sound collection unit 10b with the external device 81, and detailed description of the other structural elements will be omitted.

As illustrated in FIG. 17, the sound collection unit 10b includes a connection terminal 36b as the interface configured to be connected with the external device 81. For example, the connection terminal 36b is compliant with the USB standard. The connection terminal 36b is configured to be connected with a connection terminal 37b installed on the external device 81 side. The connection terminal 37b is also compliant with the same USB standard. Therefore, the connection terminal 36b corresponds to the plug part 36a in the example illustrated in FIG. 14, and the connection terminal 37b corresponds to the jack part 37a in the example illustrated in FIG. 14. When the connection terminal 36b is connected with the connection terminal 37b, the sound collection unit 10b and the external device 81 are connected. For example, FIG. 18 illustrates a situation in which the external device 81 and the sound collection unit 10b are connected. As illustrated in FIG. 18, in the sound collection system 2b, the directivity of the sound collection unit 10b is toward the long-length direction of the supporting member 131 indicated by the reference sign D1.

Note that, as illustrated in FIG. 18, it is possible for the sound collection system 2b to use a structural element of the external device 81 corresponding to the so-called headphone jack (in other words, the jack part 37a in the example illustrated in FIG. 14) for other purpose even in the case where the sound collection unit 10b is connected with the external device 81. Accordingly, for example, it is possible to operate the sound collection system 2b such that an audio device such as earphones or headphones is connected with the headphone jack of the external device 81 and sound collection results of the sound collection unit 10b are output via the audio device.

### Second Implementation Example of Removable Sound Collection Unit

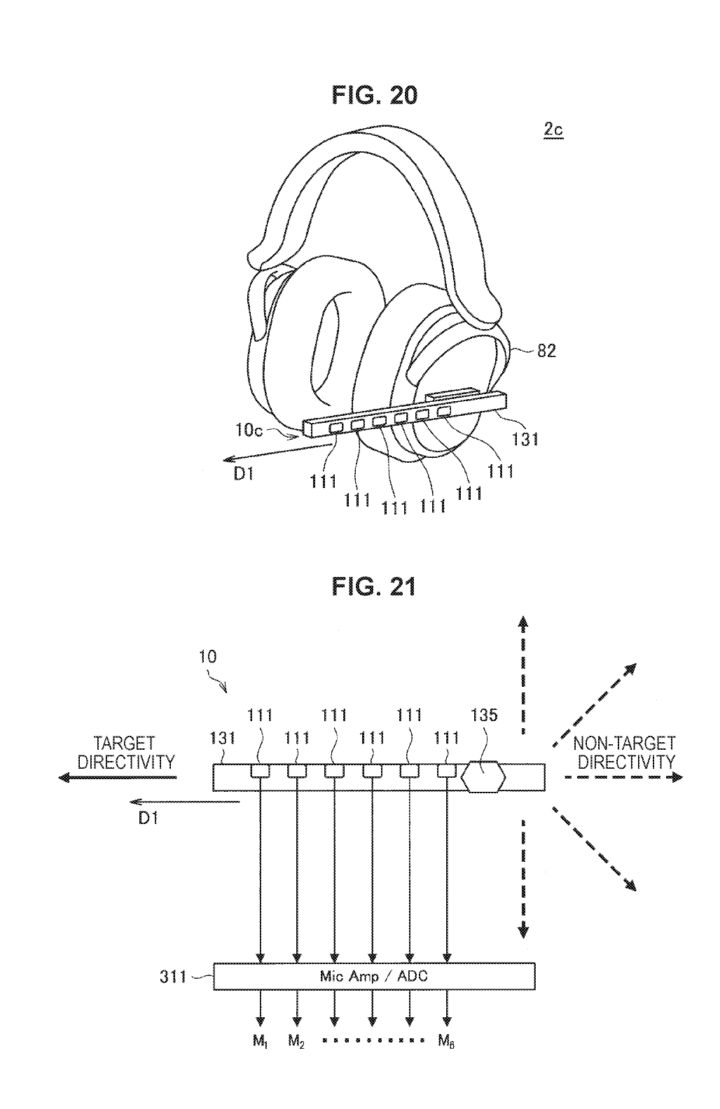

Next, another implementation example of the removable sound collection unit 10′ will be described. In the above-described example with reference to FIG. 14 to FIG. 18, the removable sound collection unit 10′ is connected with the information processing device such as a smartphone serving as the external device. However, the external device that is connected with the removable sound collection unit 10′ is not limited to the information processing terminal such as a smartphone. For example, FIG. 19 and FIG. 20 are explanatory diagrams illustrating another example of the removable sound collection unit 10′ according to the fourth modification. FIG. 19 and FIG. 20 illustrate an example of the sound collection unit 10′ that is detachably attached to so-called headphones serving as the external device. Note that, to distinguish the sound collection unit 10′ illustrated in FIG. 19 and FIG. 20 from the other sound collection units, sometimes the sound collection unit 10′ illustrated in FIG. 19 and FIG. 20 will be referred to as a “sound collection unit 10c” in the following description.

As illustrated in FIG. 19, a sound collection system 2c includes the sound collection unit 10c and an external device 82 configured as an audio device such as so-called headphones. The sound collection unit 10c includes the plurality of sound collection parts 111, the supporting member 131, and a connection terminal 36c. The supporting member 131 has a long shape, and the connection terminal 36c is configured to connect with the external device 82. The supporting member 131 supports the plurality of sound collection parts 111 at different positions along the long-length direction.

In addition, the external device 82 includes a connection terminal 37c configured to connect with the connection terminal 36c of the sound collection unit 10c. Accordingly, when the connection terminal 36c is connected with the connection terminal 37c, the sound collection unit 10c and the external device 82 are connected. For example, FIG. 20 illustrates a situation in which the external device 82 and the sound collection unit 10c are connected. Note that, as illustrated in FIG. 20, structural elements (especially, the connection terminal 36c) of the sound collection unit 10c and the connection terminal 37c of the external device 82 may be preferably configured such that the direction D1 of directivity of the sound collection unit 10c substantially matches a gaze direction of a user wearing the external device 82 in the case where the sound collection unit 10c and the external device 81 are connected.

Alternatively, the sound collection system 2c may be configured to be able to switch the direction D1 of directivity of the sound collection unit 10c like the example illustrated in FIG. 1 and FIG. 2 under a situation where the external device 82 and the sound collection unit 10c are connected as illustrated in FIG. 20. In such a case, it is possible to install a structural element configured to swing the supporting member 131 (in other words, a structural element corresponds to the rotation part 135 illustrated in FIG. 1 and FIG. 2) on the sound collection unit 10c side, for example. Alternatively, as another example, it is possible to install a structural element for switching the direction D1 of directivity of the sound collection unit 10c (such as a structural element for changing a direction of the connection terminal 37c) by rotating the sound collection unit 10c as a whole, on the external device 82 side.

As the fourth modification, the examples of the sound collection unit 10 configured to be removable from an external device (in other words, removable sound collection unit 10′) have been described above with reference to FIG. 13 to FIG. 20.

### 2.5. Fifth Modification: Example of Sound Process

Next, as a fifth modification, an example of a so-called sound process such as the beamforming will be described. The sound process is performed by the driver 31 of the sound collection device 1 on sound signals based on respective sound collection results of the sound collection parts 111 of the sound collection unit 10.

In the above-described examples, a target sound is mainly acquired by controlling directivity of the sound collection unit 10 that collects sound such that the directivity is toward the long-length direction of the supporting member 131 (in other words, model of sound collection in one direction). On the other hand, when directivity (beam) is toward a direction other than a direction from which a target sound is coming, it is also possible to acquire sounds coming from the directions other than the direction from which the target sound is coming (such as masking sounds) while discriminating the sounds by their directions.

Therefore, in the fifth modification, it is possible to acquire a target sound in a preferred manner by aiming directivity at directions other than a direction from which the target sound comes. For example, FIG. 21 is an explanatory diagram illustrating an overview of a sound collection device 1 according to the fifth modification. Note that, in the following description, sometimes directivity to a direction from which a target sound comes (in other words, long-length direction D1 of supporting member 131) as illustrated in FIG. 21 is referred to as a “target directivity”, and directivity to a direction other than the direction from which the target sound comes is referred to as a “non-target directivity”, as illustrated in FIG. 21. In addition, here, the sound collection unit 10 includes six sound collection parts 111 as illustrated in FIG. 21. Sometimes sound signals based on respective sound collection results of the sound collection parts 111 may be distinguished from each other such as an input signals M₁, M₂, . . . , M₆.

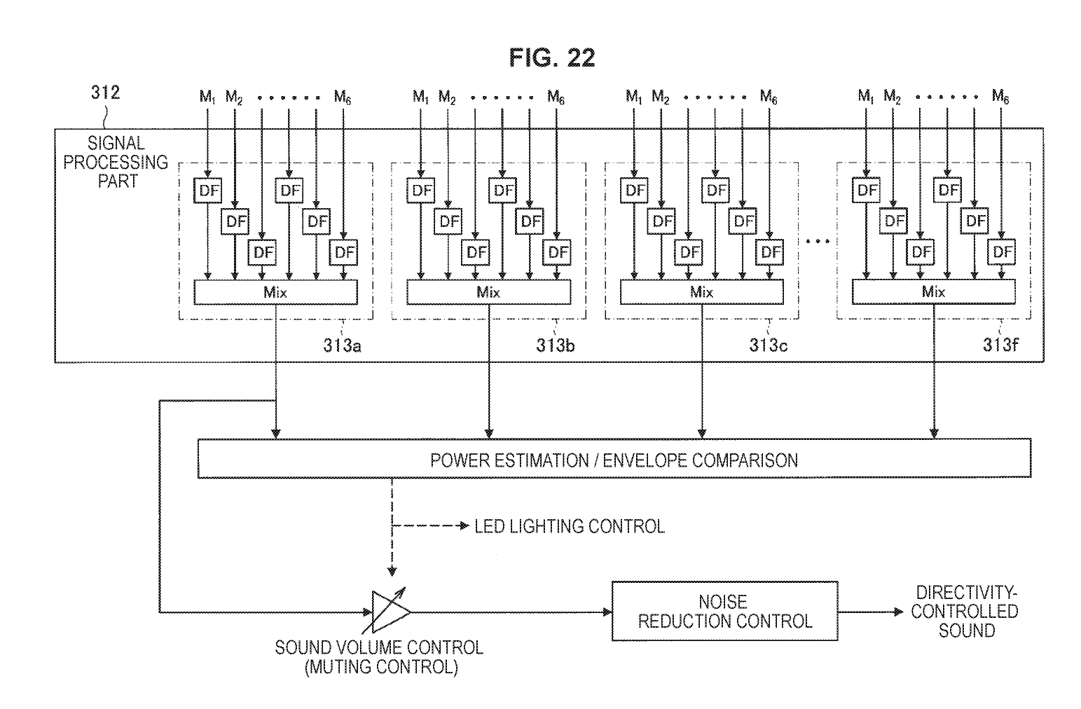

For example, FIG. 22 is an explanatory diagram illustrating an example of a sound process performed by the sound collection device 1 according to the fifth modification. FIG. 22 illustrates an example of a functional configuration for performing the so-called beamforming process on the input signals M₁, M₂, . . . , M₆ based on the respective sound collection results of the sound collection parts 111.

As illustrated in FIG. 22, the signal processing unit 312 of the sound collection device 1 according to the fifth modification includes a signal processing unit 313a related to control of target directivity and signal processing units 313b to 313f related to control of non-target directivity. Note that, the signal processing units 313 related to control of non-target directivity may be provided for respective directions that are targets of directivity control. For example, in the example illustrated in FIG. 22, the signal processing units 313b to 313f are provided as respective signal processing units 313 corresponding to five directions other than the direction from which a target sound comes.

Note that, the signal processing units 313a to 313f set filter coefficients for beamforming processes (such as delay amounts corresponding to sound collection timings of the respective sound collection parts 111) for digital filters 314 in accordance with a direction that is a target of the directivity control. The digital filters 314 are used for performing filtering processes on the respective input signals M₁, M₂, . . . , and M₆. Such a configuration enables the sound collection device 1 according to the first modification to separately control target directivity and non-target directivity.

According to such a configuration, it is possible for the sound collection device 1 in the example illustrated in FIG. 22 to recognize not only a target sound but also masking sounds of respective directions, by performing an analysis process such as power estimation or envelope comparison on the basis of respective sound signals output from the signal processing units 313a to 313f (in other words, sound signals whose directivity is controlled with regard to respective directions).

According to such a configuration, it is possible for the sound collection device 1 in the example illustrated in FIG. 22 to suppress (mute) a sound volume of a masking sound or control a dynamic range (in other words, control sound volume) through a compressor, limiter, or the like in accordance with a direction from which the masking sound comes in the case where the sound volume of the masking sound is obviously larger than a target sound, for example. Next, the sound whose sound volume is controlled is subjected to a so-called noise reduction process such as spectral subtraction (SS) such that routine noises are eliminated in a frequency domain. Subsequently, a result of the noise reduction process is output as a target sound whose directivity is controlled (directivity-controlled sound). In addition, for example, it is also possible for the sound collection device 1 to notify a user of a target sound recognition state, a masking sound recognition state, and a sound volume control state depending on the target sound recognition state and the masking sound recognition state, by controlling lighting of an LED or the like in accordance with a target sound recognition result and a masking sound recognition result.

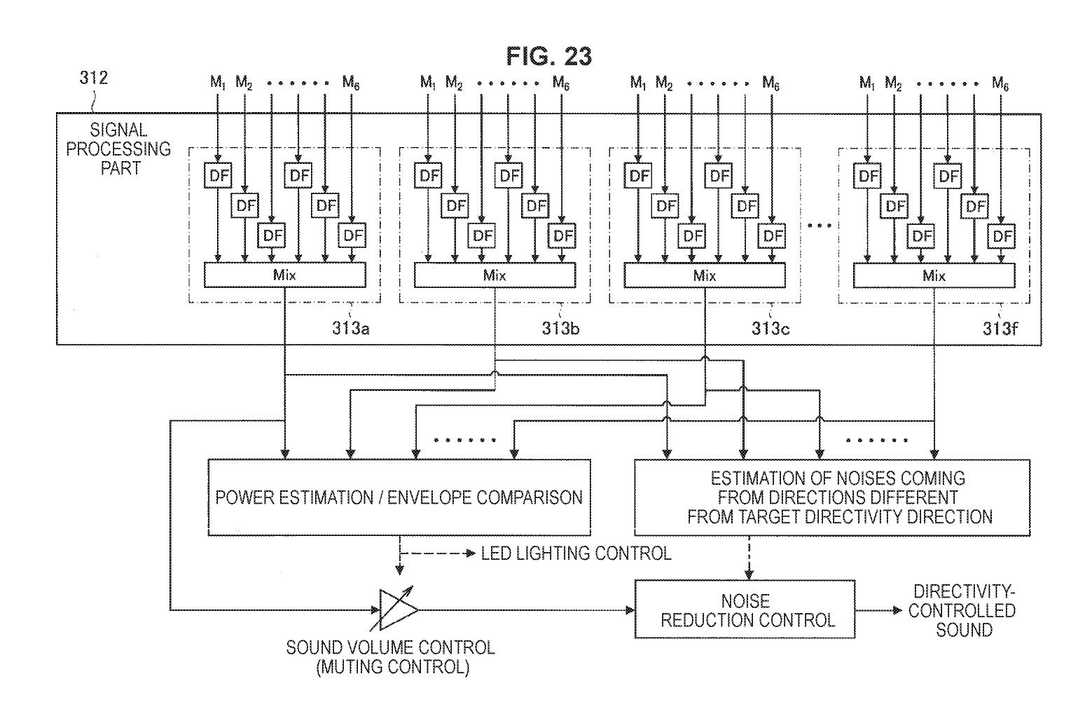

In addition, FIG. 23 is an explanatory diagram illustrating another example of the sound process performed by the sound collection device 1 according to the fifth modification. FIG. 23 illustrates another example of the functional configuration for performing the so-called beamforming process on the input signals M1, M2, . . . , and M6 based on the respective sound collection results of the sound collection parts 111. The example illustrated in FIG. 23 is different from the example illustrated in FIG. 22 in that noise reduction control is performed on a sound signal output from a signal processing unit 313a on the basis of sound signals output from the signal processing units 313b to 313f (in other words, non-target directivity control result). Here, the example illustrated in FIG. 23 will be described while focusing on a structure different from the example illustrated in FIG. 22.

Specifically, in the example illustrated in FIG. 23, the sound collection device 1 estimates sounds (in other words, masking sounds) coming from directions different from a target sound as noises for respective directions, on the basis of sound signals output from the signal processing units 313a to 313f. Therefore, in the example illustrated in FIG. 23, it is possible for the sound collection device 1 to suppress masking sounds coming from the directions different from the target sound in the sound signal output from the signal processing unit 313a, for respective directions by using the noise estimation result for the noise reduction process. In other words, the configuration illustrated in FIG. 23 enables the sound collection device 1 to acquire the target sound with a high S/N ratio.

As the fifth modification, the example of a so-called sound process such as the beamforming has been described above. The sound process is performed by the driver 31 of the sound collection device 1 on sound signals based on respective sound collection results of the sound collection parts 111 in the sound collection unit 10.

### 2.6. Sixth Modification: Implementation Example to Wearable Device

Next, as a sixth modification, an example will be described in which the sound collection unit 10 according to the embodiment is installed in a wearable device configured to be worn on a head. Note that, here, an example in which the sound collection unit 10 according to the embodiment is installed in a so-called glasses-type wearable terminal will be described.

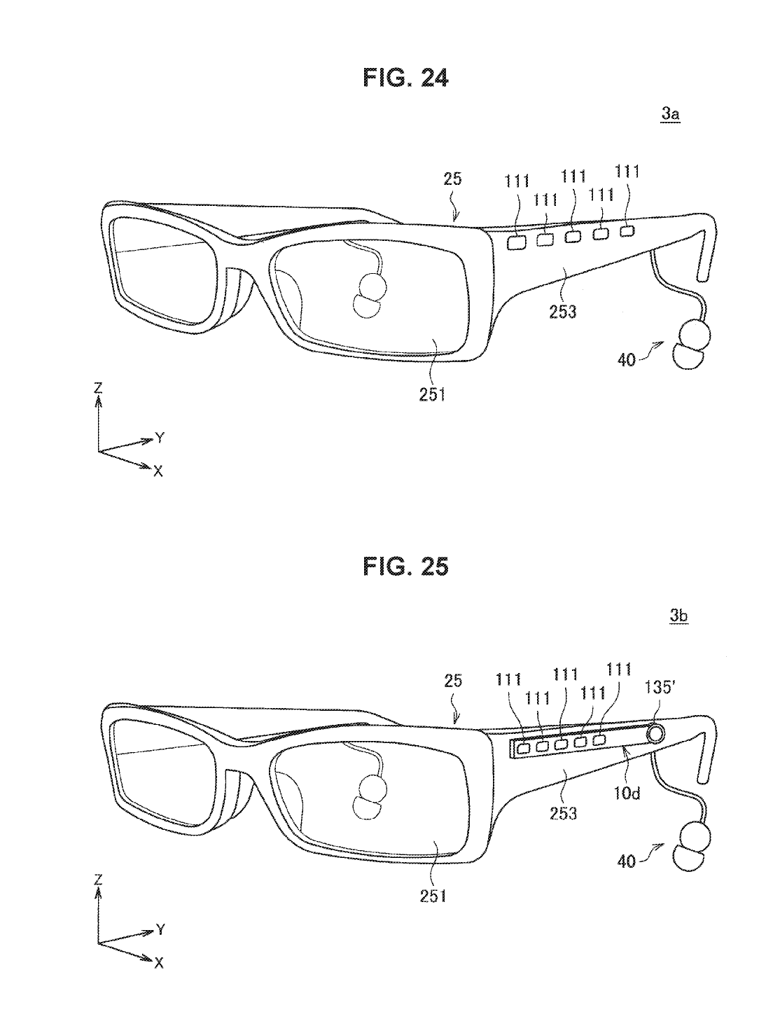

For example, FIG. 24 is an explanatory diagram illustrating an example of a schematic configuration of a sound collection device according to the sixth modification. As illustrated in FIG. 24, a sound collection device 3a is configured as the so-called glasses-type wearable device, and a portion of the sound collection device 3a is a structural element corresponding to the sound collection unit 10 according to the embodiment. Note that, in the example illustrated in FIG. 24, the configuration of the sound collection device 3a will be described while a direction corresponding to a left-right direction of the glasses is referred to as an x direction, a direction corresponding to a front-rear direction is referred to as a y direction, and a direction corresponding to an up-down direction is referred to as a z direction.

Specifically, the sound collection device 3a is configured as a glasses-type wearable device 25 with a plurality of sound collection parts 111 and earphone parts 40. Note that, for example, portions corresponding to lenses 251 of the glasses-type wearable device 25 may serve as display parts configured to provide display information.

The sound collection device 3a uses a portion of a frame of the glasses-type wearable device 25 corresponding to a temple 253 as a supporting member for supporting the plurality of sound collection parts 111 (in other words, supporting member 131 in the sound collection device 1 illustrated in FIG. 1). According to such a configuration, the sound collection device 3a performs the so-called beamforming process on sound signals based on respective sound collection results of the plurality of sound collection parts 111, acquires a sound coming from a gaze direction of a user as a target sound, and outputs the acquired target sound from the earphone parts 40. Accordingly, it is possible for the user wearing the sound collection device 3a to hear the target sound coming from his/her gaze direction in a preferred manner.

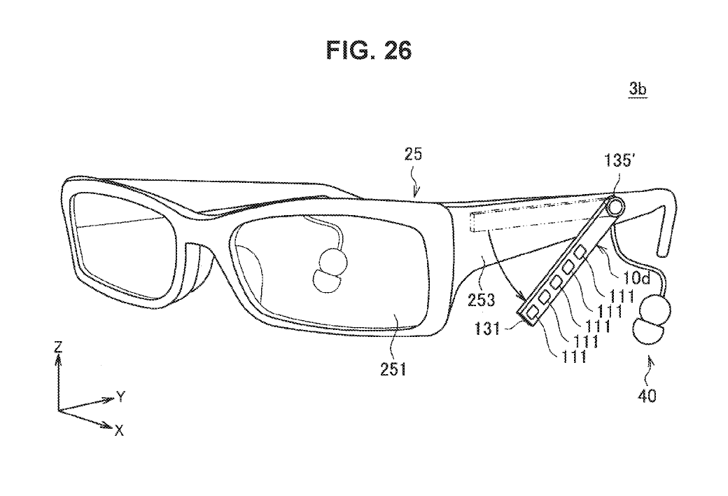

In addition, like the example illustrated in FIG. 1 and FIG. 2, it is possible to rotatably install a structural element corresponding to the sound collection unit 10 on the so-called glasses-type wearable device, as another example. For example, FIG. 25 and FIG. 26 are explanatory diagrams illustrating the another example of the schematic configuration of the sound collection device according to the sixth modification. FIG. 25 and FIG. 26 illustrate an example in which the structural element corresponding to the sound collection unit 10 is rotatably installed on the so-called glasses-type wearable device. Note that, to distinguish a structural element corresponding to the sound collection unit 10 illustrated in FIG. 25 and FIG. 26 from the other sound collection units, sometimes the structural element corresponding to the sound collection unit 10 illustrated in FIG. 25 and FIG. 26 will be referred to as a “sound collection unit 10d” in the following description. In addition, to distinguish the sound collection device illustrated in FIG. 25 and FIG. 26 from the sound collection device 3a illustrated in FIG. 24, sometimes the sound collection device illustrated in FIG. 25 and FIG. 26 will be referred to as a “sound collection device 3b”. In addition, in the example illustrated in FIG. 25 and FIG. 26, the configuration of the sound collection device 3b will be described while a direction corresponding to a left-right direction of the glasses is referred to as an x direction, a direction corresponding to a front-rear direction is referred to as a y direction, and a direction corresponding to an up-down direction is referred to as a z direction.

As illustrated in FIG. 25 and FIG. 26, the sound collection unit 10d of the sound collection device 3b is supported such that the sound collection unit 10d is capable of swinging up and down (z direction in FIG. 25 and FIG. 26) with respect to the temple 253 of the frame of the glasses-type wearable device 25.

Specifically, the sound collection unit 10d includes a plurality of sound collection parts 111, a supporting member 131, and a rotation part 135′. The supporting member 131 has a long shape and supports the plurality of sound collection parts 111 at respective positions different from each other along a long-length direction. In addition, the rotation part 135′ is connected with a vicinity of a rear-side end of the supporting member 131, and the rotation part 135′ is also connected with a portion of the temple 253 (for example, a face of the temple 253). According to such a structure, the sound collection unit 10d is supported such that the sound collection unit 10d is capable of swinging up and down with respect to the temple 253 of the glasses-type wearable device 25.

For example, FIG. 25 illustrates a situation in which the sound collection unit 10 swings upward. In the situation illustrated in FIG. 25, the sound collection unit 10d is supported in a way similar to the example illustrated in FIG. 1, such that the long-length direction of the supporting member 131 substantially matches the gaze direction of the user wearing the sound collection device 3b. In other words, in the state illustrated in FIG. 25, the sound collection unit 10 is capable of collecting sound from a sound source positioned in the gaze direction of the user (such as voice of another user) with a higher S/N ratio.

In addition, FIG. 26 illustrates a situation in which the sound collection unit 10d swings downward. For example, in the situation illustrated in FIG. 26, the sound collection unit 10d is supported in a way similar to the example illustrated in FIG. 2, such that the front-side end of the of the supporting member 131 is positioned near the mouth of the user wearing the sound collection device 3b. Accordingly, in the state illustrated in FIG. 26, the sound collection unit 10d is capable of mainly collecting voice of the user wearing the sound collection device 3b with a higher S/N ratio.

Note that, as illustrated in FIG. 25, the long-length direction of the supporting member 131 may substantially match the extending direction of the temple 253 in the situation in which the sound collection unit 10d swings upward. Therefore, for example, at least a portion of the sound collection unit 10d of the sound collection device 3b may be stored in at least a portion of the temple 253 in a situation in which the sound collection device 10d swings upward.

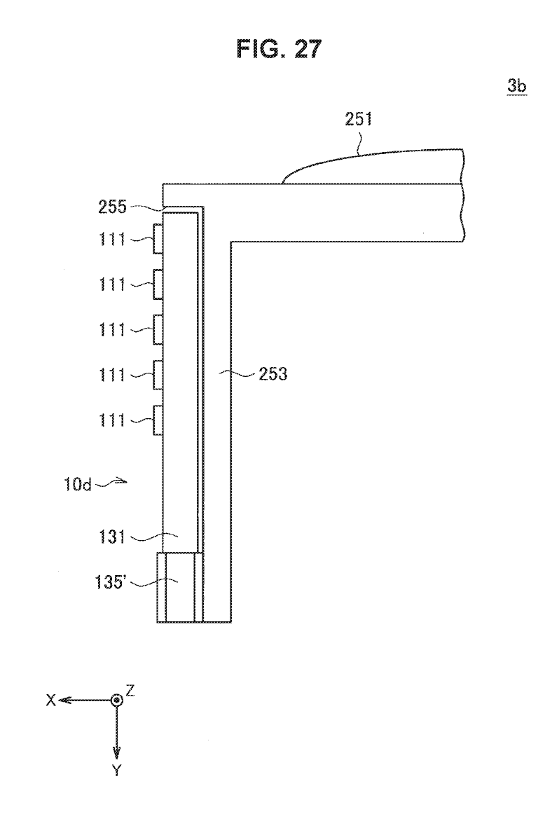

For example, FIG. 27 is an explanatory diagram illustrating another example of the schematic configuration of the sound collection device 3b according to the sixth modification. FIG. 27 illustrates an example of a structure for storing at least a portion of the sound collection unit 10d in a portion of the glasses-type wearable device 25. Note that, FIG. 27 is an example of an enlarged schematic view of a vicinity of the sound collection unit 10d of the sound collection device 3b in FIG. 25 when viewed from a z direction (when viewed from above).

In the example illustrated in FIG. 27, the sound collection device 3b has a long notch part 255 on an outer surface (x-direction side) of the temple 253. The long notch part 255 extends toward a rear side (y direction). In addition, the sound collection unit 10d is supported by the temple 253 such that the rotation part 135′ of the sound collection unit 10d is positioned at a rear side in the notch part 255. In this case, a length between a front-side end of the notch part 255 and a position of the rotation part 135′ becomes longer than a length of the supporting member 131 in the long-length direction.

According to such a structure, in the example illustrated in FIG. 27, it is possible to store the supporting member 131 in the notch part 255 in the case where the sound collection unit 10d swings upward as illustrated in FIG. 25. Note that, in the example illustrated in FIG. 27, it is preferable that the respective sound collection parts 111 protrudes from the inside of the notch part 255 toward the outside (x-direction side) even in a state in which the sound collection unit 10d swings upward and the supporting member 131 is stored in the notch part 255.

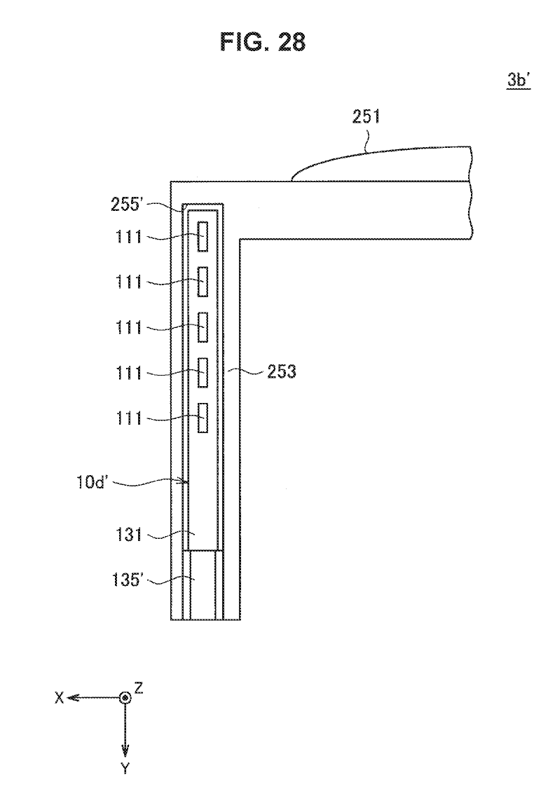

In addition, FIG. 28 is an explanatory diagram illustrating another example of the schematic configuration of the sound collection device according to the sixth modification. FIG. 28 illustrates another example of a structure for storing at least a portion of the sound collection unit 10d in a portion of the glasses-type wearable device 25. Note that, FIG. 28 is another example of the enlarged schematic view of the vicinity of the sound collection unit 10d of the sound collection device 3b in FIG. 25 when viewed from the z direction (when viewed from above). Note that, to distinguish the sound collection device 3b illustrated in FIG. 28 from the sound collection device 3b illustrated in FIG. 27, sometimes the sound collection device 3b illustrated in FIG. 28 will be referred to as a “sound collection device 3b” in the following description. In a similar way, to distinguish the sound collection unit 10d illustrated in FIG. 28 from the sound collection unit 10d illustrated in FIG. 27, sometimes the sound collection unit 10d illustrated in FIG. 28 will be referred to as a “sound collection unit 10d′” in the following description.

In the example illustrated in FIG. 28, the sound collection device 3b′ has a long opening part 255′ in the front-rear direction (y direction) such that the opening part 255′ passes through the temple 253 in the up-down direction (z direction). In addition, the sound collection unit 10d′ is supported by the temple 253 such that the rotation part 135′ of the sound collection unit 10d′ is positioned at a rear side in the opening part 255′. In this case, a length between a front-side end of the opening part 255′ and a position of the rotation part 135′ becomes longer than a length of the supporting member 131 in the long-length direction.

According to such a structure, in the example illustrated in FIG. 28, it is possible to store the supporting member 131 in the opening part 255′ in the case where the sound collection unit 10d′ swings upward as illustrated in FIG. 25. Note that, in the example illustrated in FIG. 28, the respective sound collection parts 111 are preferably supported at a position at which the respective sound collection parts 111 do not interfere with the temple 253 (for example, at an inner surface of the opening part 255′) when the sound collection unit 10d swings upward and the supporting member 131 is stored in the opening part 255′. As a specific example, in the example illustrated in FIG. 28, the respective sound collection parts 111 are supported on the upper surface (z-direction side) of the supporting member 131 such that the respective sound collection parts 111 are on positions different from each other along the long-length direction (y direction) of the supporting member 131. In addition, in the example illustrated in FIG. 28, it is preferable that the respective sound collection parts 111 protrude from the inside of the opening part 255′ toward the upper side (z-direction side) even in a state in which the sound collection unit 10d′ swings upward and the supporting member 131 is stored in the opening part 255′.

As the sixth modification, the example has been described in which the sound collection unit 10 according to the embodiment is installed as a portion of the wearable device configured to be worn on a head.

### 2.7. Seventh Modification: Control Example Using Detection of Speech

Next, as a seventh modification, an example will be described in which the sound collection device 1 according to the embodiment detects speech of a user wearing the sound collection device 1 and controls various kinds of operation to be performed by the sound collection unit 10 in accordance with a result of the detection. Note that, to distinguish the sound collection device 1 according to the seventh modification from the sound collection device 1 illustrated with reference to FIG. 1 and FIG. 2, sometimes the sound collection device 1 according to the seventh modification will be referred to as a “sound collection device 4” in the following description.

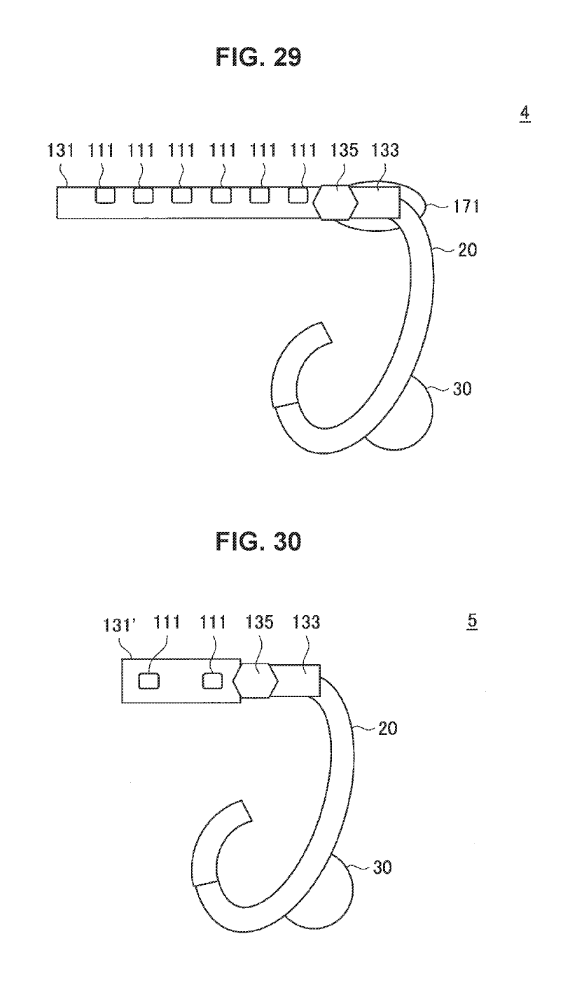

For example, FIG. 29 is an explanatory diagram illustrating an example of a schematic configuration of the sound collection device 4 according to the seventh modification. As illustrated in FIG. 29, the sound collection device 4 according to the seventh modification is different from the sound collection device 1 described with reference to FIG. 1 and FIG. 2 in that the sound collection device 4 according to the seventh modification includes a speech detection part 171. Accordingly, the configuration of the sound collection device 4 according to the seventh modification will be described here while focusing on a portion different from the sound collection device 1 described with reference to FIG. 1 and FIG. 2. Detailed descriptions of the other structural elements that are substantially similar to the sound collection device 1 will be omitted here.

For example, the speech detection part 171 is configured to be capable of detecting vibration such as a so-called vibration sensor or bone conduction microphone. The speech detection part 171 is supported by at least a portion of the sound collection device 4 (such as a portion of the wearable part 20) such that a portion configured to detect vibration comes into contact with at least a position of a head of a user in the case where the user is wearing the sound collection device 4. Such a configuration enables the speech detection part 171 to detect vibration that occurs from speech in the case where the user wearing the sound collection device 4 speaks. Accordingly, it is possible for the sound collection device 4 to detect speech from a user wearing the sound collection device 4 on the basis of a detection result of the speech detection part 171.

According to such a configuration, the sound collection device 4 according to the seventh modification controls operation related to sound collection performed by the sound collection unit 10 in accordance with a result of detection of speech from a user performed by the speech detection part 171, for example.

As a specific example, a situation will be described where the supporting member 131 of the sound collection unit 10 swings upward as illustrated in the example illustrated in FIG. 1 and a user wearing the sound collection device 4 speaks with another user who is positioned in front of the user wearing the sound collection device 4. In such a case, for example, it is assumed that the another user who is a conversation target does not speak while the user wearing the sound collection device 4 is speaking. Therefore, for example, it is also possible for the sound collection device 4 to perform control such that a process of collecting sounds by the plurality of sound collection part 111 (in other words, sound collection directivity control) is suppressed in the case of detecting speech from the user wearing the sound collection device 4. Accordingly, the voice of the user wearing the sound collection device 4 is collected again by the sound collection unit 10. As a result, it is possible to prevent increase in gain of the voice of the user and prevent such an increased gain to be heard, thereby reducing a feeling of strangeness.

In addition, as another example, a situation will be described where the supporting member 131 of the sound collection unit 10 swings downward like the example illustrated in the example in FIG. 2 and voice of the user wearing the sound collection device 4 is collected. In such a case, it is preferable that sound is collected such that a sound volume of voice of the user wearing the sound collection device 4 gets larger and the other sounds (such as noise like surrounding sounds) are suppressed. Therefore, for example, the sound collection device 4 acquires sound signals based on sound collection results of the respective sound collection parts 111 in the case where speech from the user wearing the sound collection device 4 is detected. In the case where the user does not speak, it is possible to suppress the sound signals based on the sound collection results of the respective sound collection parts 111.

Note that, the above-described examples are mere examples. Therefore, a type of a process to be controlled and content of the process are not specifically limited as long as it is possible for the sound collection device 4 to control various kinds of processes in accordance with a result of detection of speech from the user wearing the sound collection device 4.

As the seventh modification, the example has been described in which the sound collection device 1 according to the embodiment detects speech of a user wearing the sound collection device 1 and controls various kinds of operation to be performed by the sound collection unit 10 in accordance with a result of the detection, with reference to FIG. 29.

### 2.8. Eighth Modification: Example of Various Sound Collection Unit

Next, as an eighth modification, an example of a sound collection device including a supporting member 131 of the sound collection unit 10 capable of stretching and shortening in the long-length direction will be described. Note that, to distinguish the sound collection device 1 according to the eighth modification from the sound collection device 1 illustrated with reference to FIG. 1 and FIG. 2, sometimes the sound collection device 1 according to the eighth modification will be referred to as a “sound collection device 5” in the following description.

For example, FIG. 30 to FIG. 32 are explanatory diagrams illustrating an example of a schematic configuration of the sound collection device 5 according to the eighth modification. As illustrated in FIG. 30 to FIG. 32, the sound collection device 5 according to the eighth modification is different from the sound collection device 1 described with reference to FIG. 1 and FIG. 2 in that a structural element corresponding to the supporting member 131 (hereinafter, referred to as a “supporting member 131′ ” is capable of stretching and shortening in the long-length direction like a so-called rod antenna. Accordingly, the configuration of the sound collection device 5 according to the eighth modification will be described here while focusing on a portion different from the sound collection device 1 described with reference to FIG. 1 and FIG. 2. Detailed descriptions of the other structural elements that are substantially similar to the sound collection device 1 will be omitted here.

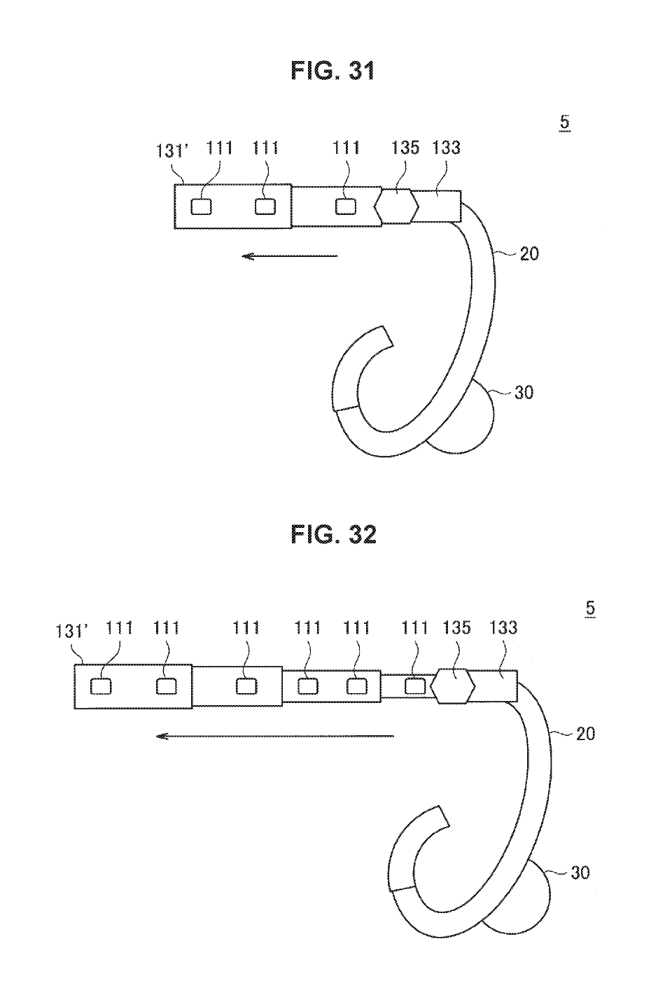

For example, FIG. 30 illustrates a situation in which a portion of a supporting member 131′ is stored in another portion of the supporting member 131′ such that the supporting member 131′ gets shortened in the long-length direction. In addition, FIG. 31 illustrates a situation in which the supporting member 131′ stretches toward the front side from the situation illustrated in FIG. 30, thereby exposing at least a part of the portion stored in the supporting member 131′. In the example illustrated in FIG. 31, at least a part of the portion stored in the supporting member 131′ is exposed. Therefore, stored sound collection parts 111 get exposed on the outside. Accordingly, in the situation illustrated in FIG. 31, it is possible to use more sound collection parts 111 for collecting sounds than the situation illustrated in FIG. 30.

In addition, FIG. 32 illustrates a situation in which the supporting member 131′ further stretches toward the front side from the situation illustrated in FIG. 31, thereby exposing more parts of the portion stored in the supporting member 131′. In the example illustrated in FIG. 32, the more part of the portion stored in the supporting member 131′ in the situation illustrated in FIG. 31 are exposed. Therefore, the number of sound collection parts 111 exposed on the outside increases. Accordingly, in the situation illustrated in FIG. 32, it is possible to use more sound collection parts 111 for collecting sounds than the situation illustrated in FIG. 31.

Note that, the structure of the sound collection device 8 according to the eighth modification is not limited to the example in which the number of sound collection parts 111 capable of collecting sounds (in other words, the number of sound collection parts 111 to be activated) is adjusted by stretching or shortening the supporting member 131′ in the long-length direction as described with reference to FIG. 30 to FIG. 34. As a specific example, it is possible to adjust intervals between the plurality of sound collection parts 111 by stretching or shortening the supporting member 131′ in the long-length direction.

In addition, the sound collection device 8 according to the eighth modification is preferably configured such that a control signal corresponding to a stretching/shortening state of the supporting member 131′ is transmitted to the driver 31 configured to perform the beamforming process on sound signals based on respective sound collection results of the plurality of sound collection parts 111. Such a configuration enables the driver 31 to recognize the stretching/shortening state of the supporting member 131′. Accordingly, it is possible for the driver 31 to recognize activated sound collection parts 111, positions of the respective sound collection parts 111, intervals between the plurality of sound collection parts 111, and the like on the basis of the stretching/shortening state of the supporting member 131′, and use them for the beamforming process.

As the eighth modification, the example of sound collection device including a supporting member 131 of the sound collection unit 10 capable of stretching and shortening in the long-length direction according to the embodiment has been described above with reference to FIG. 30 to FIG. 32.

### 2.9. Ninth Modification: Example of Case of Causing Plurality of Sound Collection Units to Cooperate with Each Other

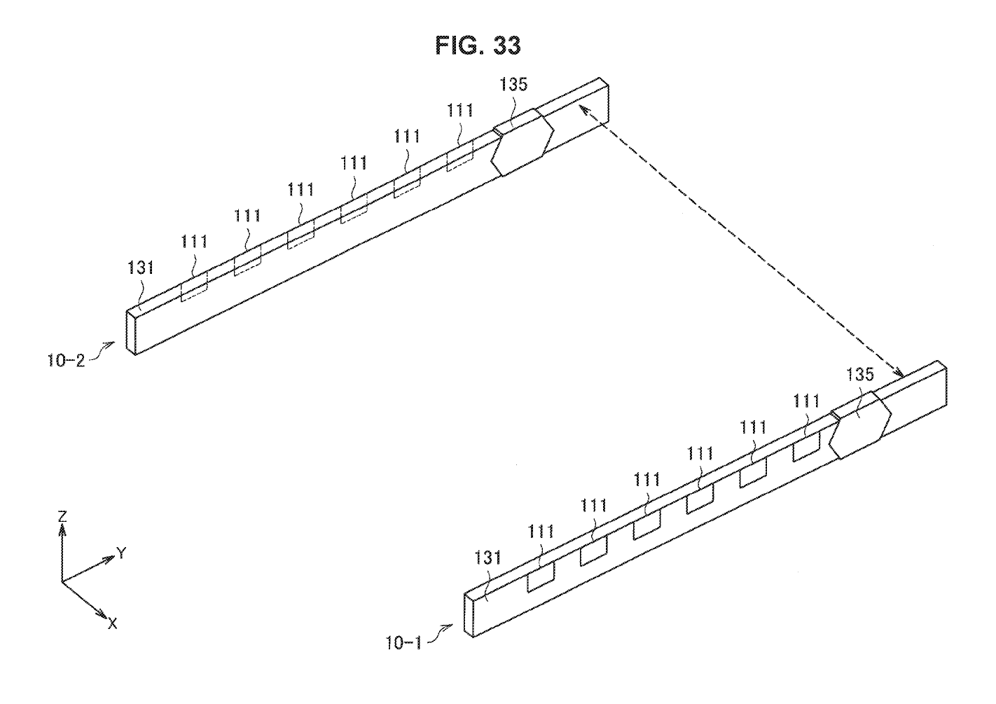

Next, as a ninth modification, an example will be described in which the plurality of sound collection units 10 operate in cooperation with each other. For example, FIG. 33 is an explanatory diagram illustrating an overview of a sound collection device according to the ninth modification. FIG. 33 illustrates an example of causing the plurality of sound collection units to cooperate with each other.

FIG. 33 illustrates an example of causing two sound collection units 10 to cooperate with each other. Note that, to distinguish the two sound collection units 10 from each other, sometimes one of the sound collection units 10 is referred to as a sound collection unit 10-1, and the other of the sound collection units 10 is referred to as a sound collection unit 10-2 here.

Note that, the sound collection unit 10-1 and the sound collection unit 10-2 may be configured to cooperate with each other by exchanging information with each other via wireless communication while using the communication parts 317 described with reference to FIG. 3, for example. In addition, as another example, the sound collection unit 10-1 and the sound collection unit 10-2 may be configured to cooperate with each other by connecting with each other via a wired network such as a cable.

Here, an example of control to be performed for causing the sound collection unit 10-1 and the sound collection unit 10-2 to cooperate with each other will be described. For example, FIG. 33 illustrates an example in which the sound collection unit 10-1 and the sound collection unit 10-2 are worn at different positions in the left-right direction (x direction) in the case where the long-length direction of the supporting member 131 is defined as the front-rear direction (y direction).

As illustrated in FIG. 33, the sound collection parts 111 of the sound collection unit 10-1 and the sound collection parts 111 of the sound collection unit 10-1 are supported at different positions in the left-right direction (x direction) in a situation in which the sound collection unit 10-1 and the sound collection unit 10-2 are worn at different positions in the left-right direction. Therefore, in the example illustrated in FIG. 33, a sound coming from the left-right direction (y direction) is collected by the sound collection parts 111 of the sound collection unit 10-1 and the sound collection unit 10-2 at different timings, for example. When causing the sound collection unit 10-1 and the sound collection unit 10-2 to cooperate with each other by using such a characteristic, it is possible to control directivity of sound collection in the left-right direction (y direction) with higher accuracy, for example.

Needless to say, the way of waring the sound collection unit 10-1 and the sound collection unit 10-2 is not limited to the example illustrated in FIG. 33. Specifically, in the case of causing the plurality of sound collection units 10 to cooperate with each other, timings of collecting a sound by the respective sound collection units 10 change in accordance with a position of a sound source of the target sound and positional relationship between the plurality of sound collection units 10. Therefore, it is possible to control directivity of target sound collection with higher accuracy, by adjusting respective wearing positions of the plurality of sound collection units 10 in accordance with a use case of causing the plurality of sound collection units 10 to cooperate with each other. In addition, the respective wearing positions of the plurality of sound collection units 10 are adjusted such that sound collection levels of the plurality of sound collection units 10 become different from each other. Accordingly, it is possible to control a dynamic range of a sound to be collected (in other words, target sound) in a preferred manner (in other words, in such a manner that a feeling of strangeness is reduced).

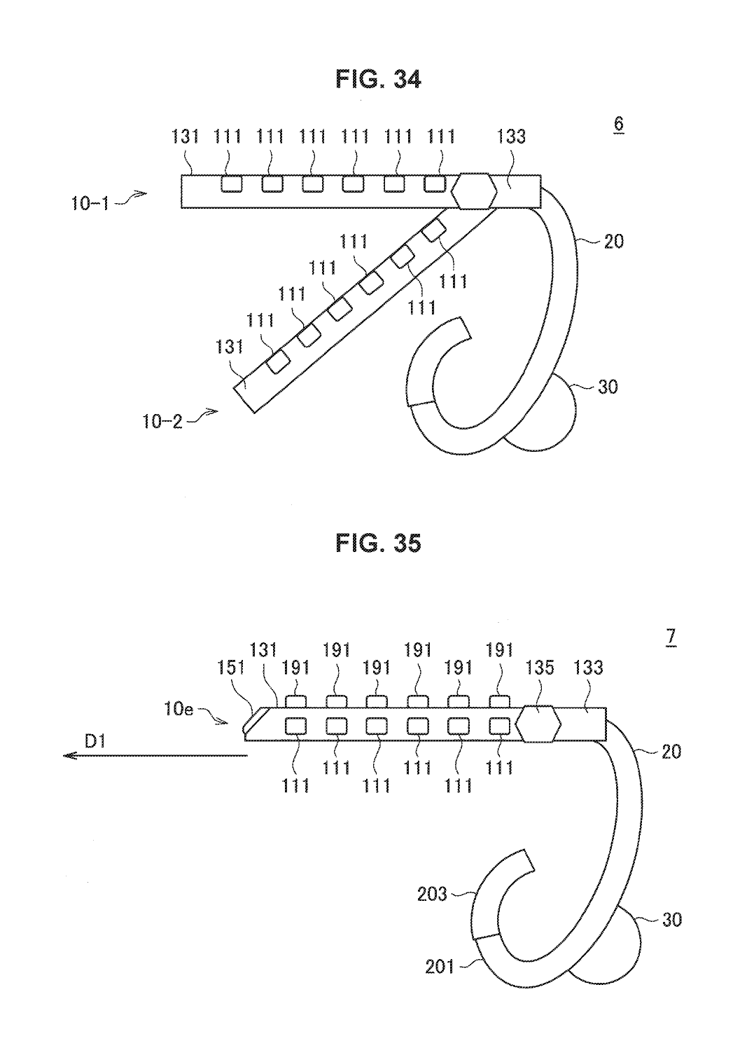

For example, FIG. 34 is an explanatory diagram illustrating another example of the sound collection device according to the ninth modification. To distinguish the sound collection device illustrated in FIG. 34 from the sound collection device 1 illustrated with reference to FIG. 1 and FIG. 2, sometimes the sound collection device illustrated in FIG. 34 will be referred to as a “sound collection device 6” in the following description.

As illustrated in FIG. 34, the sound collection device 6 includes the plurality of sound collection units 10-1 and 10-2 such that the long-length directions of the supporting members 131 of the sound collection units 10-1 and 10-2 face different directions from each other. Specifically, the sound collection unit 10-1 is supported such that the long-length direction of the supporting member 131 (in other words, the front-side end of the supporting member 131) is toward a gaze direction of a user wearing the sound collection device 6. In addition, the sound collection unit 10-2 is supported such that the front-side end of the supporting member 131 is positioned near the mouth of the user wearing the sound collection device 6.

According to such a configuration, the sound collection unit 10-1 in the sound collection device 6 mainly collects a sound coming from the front side of the user wearing the sound collection device 6, and the sound collection unit 10-2 mainly collects voice of the user.

In addition, as illustrated in FIG. 34, the long-length directions of the respective supporting members 131 of the sound collection units 10-1 and 10-2 are toward different directions from each other along elevation angle directions. According to such a structure, a sound coming from the up-down direction (z direction) is collected by the sound collection parts 111 of the sound collection unit 10-1 and the sound collection unit 10-2 at different timings, for example. Therefore, it is possible for the sound collection device 6 illustrated in FIG. 34 to suppress effects of sounds reflected by a floor or a ceiling, and acquire a sound signal based on a sound coming from the front side (in other words, target sound) with a high S/N ratio, for example.

In addition, it is possible for each of the sound collection units 10-1 and 10-2 to include the rotation part 135. As a specific example, each of the sound collection units 10-1 and 10-2 illustrated in FIG. 33 may include the rotation part 135 such that each of the supporting members 131 is capable of swinging upward and downward as illustrated in FIG. 1 and FIG. 2. In such a case, it is possible for each of the sound collection units 10-1 and 10-2 to control operations related to sound collection in accordance with a rotation state of each supporting member 131, for example.

As a specific example, the sound collection units 10-1 and 10-2 are assumed to be used for different purposes in the case where one of the supporting members 131 of the sound collection units 10-1 and 10-2 swings upward and the other of the supporting members 131 swings downward. In such a case, the sound collection units 10-1 and 10-2 may operate independently from each other.

On the other hand, the sound collection units 10-1 and 10-2 are assumed to be used for a same purpose in the case where the supporting members 131 of the sound collection units 10-1 and 10-2 both swing upward or downward. In such a case, the sound collection units 10-1 and 10-2 may operate in cooperation with each other.

In addition, the number of sound collection parts 111 to be activated may be controlled in the case where the sound collection units 10-1 and 10-2 operate in cooperation with each other as illustrated in the example illustrated in FIG. 33 and FIG. 34. As a specific example, the number of sound collection parts 111 to be activated may be controlled such that the number of activated sound collection parts 111 of the sound collection units 10-1 and 10-2 is less than or equal to a threshold.

As a specific example, in the case where each of the sound collection units 10-1 and 10-2 includes six sound collection parts 111 (in other words, in the case of six channels), sound collection parts 111 of each of the sound collection units 10-1 and 10-2 may be selectively activated such that six channels are activated as a total. In such a case, for example, sound collection parts 111 corresponding to two channels may be activated in the sound collection unit 10-1, and sound collection parts 111 corresponding to four channels may be activated in the sound collection unit 10-2. Alternatively, as another example, sound collection parts 111 corresponding to three channels may be activated in each of the sound collection units 10-1 and 10-2. Such a configuration enables electric power consumption to be suppressed, for example.

In addition, it is possible to control the number of sound collection parts 111 and positions of sound collection parts 111 to be activated in the sound collection units 10-1 and 10-2, in accordance with a use case. As a specific example, it is possible to control the number of sound collection parts 111 and positions of sound collection parts 111 to be activated in the sound collection units 10-1 and 10-2, in accordance with swinging states of the respective supporting members 131 of the sound collection units 10-1 and 10-2. In addition, as illustrated in FIG. 33 and FIG. 34, it is also possible to control the number of sound collection parts 111 and positions of the sound collection parts 111 to be activated in a sound collection unit 10, not only in the case of causing the plurality of sound collection units 10 to cooperate with each other, but also in the case where there is only one sound collection unit 10 as illustrated in FIG. 1 and FIG. 2.

Note that, in the case of causing the plurality of sound collection units 10 to cooperate with each other, a main controller thereof is not specifically limited. As a specific example, one of the sound collection units 10 may serve as the main controller and control operation of the other sound collection unit 10. Alternatively, as another example, the plurality of sound collection units 10 may be configured such that each of the sound collection units 10 operates independently from each other in accordance with a operation state of the other sound collection units 10 and cooperates with each other.

As the ninth modification, the example has been described in which the plurality of sound collection units 10 operates in cooperation with each other. Note that, the above description has focused on a case of causing the plurality of sound collection units 10 to operate in cooperation with each other. However, needless to say, the same applies to a case where a plurality of the sound collection device 1 operates in cooperation with each other.

### 2.10. Tenth Modification: Implementation Example to Directional Speaker

Next, as a tenth modification, an example will be described in which the sound collection device 1 according to the embodiment includes a so-called directional speaker configured to output a sound toward the long-length direction of the supporting member 131. Note that, to distinguish the sound collection device 1 according to the tenth modification from the sound collection device 1 illustrated with reference to FIG. 1 and FIG. 2, sometimes the sound collection device 1 according to the tenth modification will be referred to as a “sound collection device 7” in the following description.

For example, FIG. 35 is an explanatory diagram illustrating an example of a schematic configuration of the sound collection device 7 according to the tenth modification. As illustrated in FIG. 35, the sound collection device 7 according to the tenth modification is different from the sound collection device 1 described with reference to FIG. 1 and FIG. 2 in that a structural element corresponding to the sound collection unit 10 in the sound collection device 7 according to the tenth modification includes a plurality of sound output parts 191. Accordingly, the configuration of the sound collection device 7 according to the tenth modification will be described here while focusing on a portion different from the sound collection device 1 described with reference to FIG. 1 and FIG. 2. Detailed descriptions of the other structural elements that are substantially similar to the sound collection device 1 will be omitted here. In addition, to distinguish the sound collection unit 10 according to the tenth modification from the sound collection unit 10 illustrated with reference to FIG. 1 and FIG. 2, sometimes the sound collection unit 10 according to the tenth modification will be referred to as a “sound collection unit 10e” in the following description.

As illustrated in FIG. 35, the sound collection unit 10e includes the plurality of sound output parts 191. Specifically, the plurality of sound output parts 191 are supported at different positions along the long-length direction of the supporting member 131. Note that, in this case, the plurality of sound output parts 191 are preferably installed at positions at which the respective sound output parts 191 do not interfere with the plurality of sound collection parts 111. For example, in the example illustrated in FIG. 35, the plurality of sound collection parts 111 are supported on a face that faces a lateral direction with respect to a user among faces of the supporting member 131, in the case where the user is wearing the sound collection device 7. In addition, the plurality of sound output parts 191 are supported on a top face among the faces of the supporting member 131.

In addition, each of the sound output parts 191 is configured as a so-called parametric speaker such that each of the sound output parts 191 is capable of outputting a sound above 20 kHz that is a so-called ultrasound (hereinafter, sometimes simply referred to as “ultrasound”). According to such a configuration, the sound collection device 7 (such as the driver 31) drives the plurality of sound output parts 191 on the basis of a sound signal of a sound output toward the front side in the long-length direction of the supporting member 131 (such as a result of collecting voice of a user wearing the sound collection device 7, for example).

Specifically, the sound collection device 7 performs various kinds of modulation on the sound signal above 20 kHz on the basis of a sound signal of an output target sound, and drives the respective sound output parts 191 on the basis of a modulated sound signal. The various kinds of modulation include amplitude modulation (AM), double sideband (DSB) modulation, single sideband (SSB) modulation, frequency modulation (FM), and the like. Note that, in this case, the sound collection device 7 controls directivity related to output of a ultrasound such that the ultrasound propagates toward the long-length direction (in other words, direction D1) of the supporting member 131 by controlling output of the sound output parts 191 in accordance with respective positions of the sound output parts 191 (specifically, positions in the long-length direction of the supporting member 131).

According to such a configuration, when an ultrasound output from each of the sound output parts 191 propagates in the air, a sound (audible sound) used for ultrasound modulation appears on a path through which the ultrasound has propagated, due to a non-linear characteristic caused by expansion of air molecules compressed by the ultrasound. Accordingly, it is possible for a user who is on a path through which the ultrasound output from each of the sound output parts 191 propagates (in other words, a path toward the long-length direction of the supporting member 131) to hear a sound obtained by modulating the ultrasound (in other words, output target sound).

Note that, in the sound collection device 7 according to the tenth modification, the plurality of sound collection parts 111 are preferably configured to collect sounds of frequency bands different from sounds output from the respective sound output parts 191 (in other words, sounds above 20 kHz). Specifically, each of the sound collection parts 111 is preferably configured to collect a sound of a band equal to or less than 20 kHz (such as a sound in an audible field), for example. Such a configuration enables each of the sound collection parts 111 to collect surrounding sounds (especially, sounds coming from the long-length direction of the supporting member 131) without being affected by sounds output from the respective sound output parts 191.

As the tenth modification, the example has been described in which the sound collection device 1 according to the embodiment includes the so-called directional speaker configured to output a sound toward the long-length direction of the supporting member 131, with reference to FIG. 35.

### 3. HARDWARE CONFIGURATION

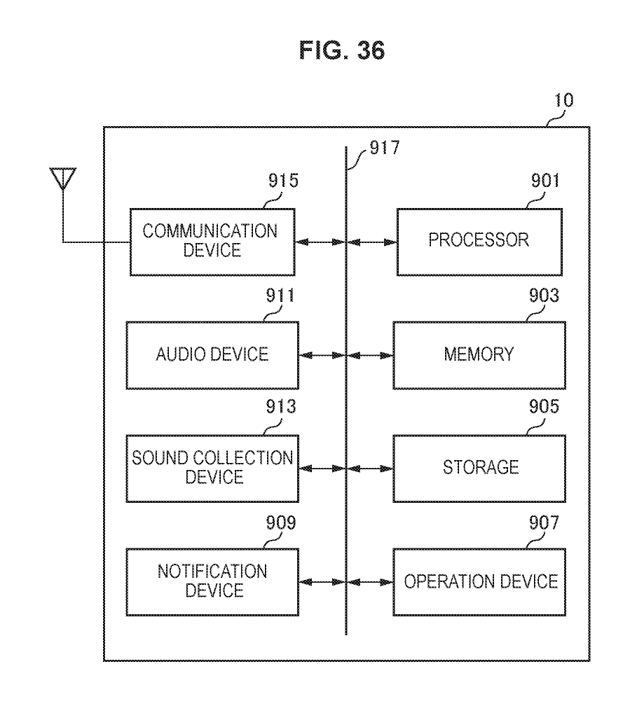

Next, with reference to FIG. 36, an example of a hardware configuration of the sound collection device 1 according to each of the embodiments of the present disclosure will be described. FIG. 36 is a diagram illustrating an example of a hardware configuration of the sound collection device 1 according to each of the embodiments of the present disclosure.

As illustrated in FIG. 36, the sound collection device 1 according to the embodiment includes a processor 901, memory 903, a storage 905, an audio device 911, a sound collection device 913, and a bus 917, for example. In addition, the sound collection device 1 may include at least any of an operation device 907, a notification device 909, and a communication device 915.

The processor 901 may be a central processing unit (CPU), a graphics processing unit (GPU), a digital signal processor (DSP), or a system on chip (SoC), and executes various processes of the sound collection device 1, for example. For example, the processor 901 may include an electronic circuit configured to perform various arithmetic processes. Note that, the AD conversion part 311, the signal processing part 312, the DA conversion part 318, and the like may be implemented by the processor 901.

The memory 903 includes random access memory (RAM) and read only memory (ROM), and stores program and data to be executed by the processor 901. The storage 905 can include a storage medium such as a semiconductor memory or a hard disk.

The operation device 907 has a function of generating an input signal for a user to perform a desired operation. For example, the operation device 907 may be a touchscreen. In addition, as another example, the operation device 907 may include: an input part to be used by the user for inputting information, such as a button, a switch, or a keyboard; an input control circuit configured to generate an input signal on the basis of user input and to supply the input signal to the processor 901; and the like.

The notification device 909 is an example of an output device. For example, the notification device 909 may be a device such as a liquid crystal display (LCD) device or an organic light emitting diode (OLED) display. In this case, it is possible for the notification device 909 to notify a user of predetermined information by displaying a screen.

Note that, the above-described examples of the notification device 909 are mere examples. The type of the notification device 909 is not specifically limited as long as it is possible to notify a user of predetermined information. As a specific example, the notification device 909 may be a device configured to notify a user of predetermined information by using light patterns such as lighting or blinking, like a light emitting diode (LED). Alternatively, the notification device 909 may be a device configured to notify a user of predetermined information by vibrating like a so-called vibrator. Note that, the above-described light-emitting part 151 may be implemented by the notification device 909.

Like the speaker, etc., the audio device 911 may be a device configured to notify a user of predetermined information by outputting a predetermined sound signal. For example, the above-described sound output part 319 may be implemented by the audio device 911.

Like the microphone, etc., the sound collection device 913 is a device configured to collect voice of a user and sounds of a surrounding environment, and acquire them as sound information (sound signals). In addition, the sound collection device 913 may acquire data of an analog sound signal indicating the collected voice and sound as the sound information. Alternatively, the sound collection device 913 may convert the analog sound signal into a digital sound signal and acquire data of the converted digital sound signal as the sound information. Note that, each of the above-described sound collection parts 111 may be implemented by the sound collection device 913.

The communication device 915 may be a communication means in the sound collection device 1. The communication device 915 is configured to communicate with external devices via a network. The communication device 915 is a wired or wireless communication interface. In the case where the communication device 915 is the wireless communication interface, the communication device 915 may include a communication antenna, a radio frequency (RF) circuit, a baseband processor, and the like.

The communication device 915 has a function of performing various kinds of signal processes on signals received from external devices. The communication device 915 is capable of supplying the processor 901 with a digital signal generated from a received analog signal. For example, the above-described communication part 317 may be implemented by the communication device 915.

The bus 917 mutually connects the processor 901, the memory 903, the storage 905, the operation device 907, the notification device 909, the audio device 911, the sound collection device 913, and the communication device 915. The bus 917 may include various kinds of buses.

In addition, it is also possible to create a program for causing hardware such as a processor, memory, and a storage, which are embedded in a computer, to execute functions equivalent to the structural elements of the sound collection device 1. Moreover, it may be possible to provide a computer-readable storage medium having the program stored thereon.

### 4. CONCLUSION

As described above, in the sound collection device 1 according to the embodiment, the sound collection unit 10 includes the long supporting member 113 and the plurality of sound collection parts 111 such that the plurality of sound collection parts 111 are supported at different positions along the long-length direction of the supporting member 131. According to such a structure, it is possible for the respective sound collection parts 111 to collects sounds at different timings especially in the case where sounds come from the long-length direction of the supporting member 131. In other words, with regard to collection of sounds coming from the long-length direction of the supporting member 131, the sound collection device 1 according to the embodiment is capable of controlling directivity with a higher accuracy on the basis of the so-called beamforming technology while using the simple structure and preventing the device from getting larger and complex. In other words, by using the sound collection device 1 according to the embodiment, it is possible to acquire target sounds in a preferred manner while preventing the device from getting larger.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A sound collection device including:

a plurality of sound collection parts;

a supporting member that has a long shape and that supports the plurality of sound collection parts at respective positions different from each other along a long-length direction; and

a signal output part that directly or indirectly outputs sound collection results of respective sounds obtained by the plurality of sound collection parts to a signal processing part that acquires a target sound coming from one side of the long-length direction on a basis of the sound collection results.

(2)

The sound collection device according to (1),

in which the supporting member is worn on a predetermined body part of a user, and the supporting member supports the plurality of sound collection parts such that a predetermined positional relation is established between the body part and each of the sound collection parts.

(3)

The sound collection device according to (2), in which

the body part is a head, and

the supporting member is worn on the head such that the one side of the long-length direction substantially matches a front side of the user.

(4)

The sound collection device according to (2) or (3), including

a sound output part that outputs a sound based on the target sound acquired by the signal processing part.

(5)

The sound collection device according to (4), including

a wearable part that supports each of the sound output part and the supporting member near an ear of the user such that a predetermined positional relation is established between the ear and each of the sound output part and the supporting member.

(6)

The sound collection device according to (5),

in which the wearable part includes a tubular sound guide part that guides a sound output from the sound output part to a vicinity of an ear opening.

(7)

The sound collection device according to (6), in which

the wearable part includes a long member installed such that the long member extends along a back side of an auricle when the sound collection device is worn, and

the supporting member is connected with one end of the long member in a long-length direction, and the sound guide part is installed at the other end thereof.

(8)

The sound collection device according to (7),

in which the wearable part includes a driving part at at least a portion of the long member, the driving part driving the sound output part.

(9)

The sound collection device according to (2) or (3), including:

a vibration part that outputs vibration based on the target sound acquired by the signal processing part, and

a wearable part that supports each of the vibration part and the supporting member such that the vibration part is in contact with at least a portion of a head of the user.

(10)

The sound collection device according to any one of (1) to (9),

in which the supporting member includes
a first member that supports the plurality of sound collection parts,
a second member that is different from the first member, and
a rotation part that rotatably connects the first member with the second member.
   (11)

The sound collection device according to any one of (1) to (10),

in which at least a portion of the supporting member is capable of stretching and shortening in the long-length direction.

(12)

The sound collection device according to (11),

in which a number of the sound collection parts to be activated changes when at least a portion of the supporting member stretches or shortens in the long-length direction.

(13)

The sound collection device according to any one of (1) to (12), including

a plurality of the supporting members that support the plurality of sound collection parts.

(14)

The sound collection device any one of (1) to (13),

in which the supporting member supports the plurality of sound collection parts such that, among intervals between the plurality of sound collection parts, at least an interval between adjacent sound collection parts is different from other intervals.

(15)

The sound collection device according to any one of (1) to (14), including

the signal processing part.

(16)

The sound collection device according to any one of (1) to (14), including

a connection part that is connected with an external device,

in which the signal output part outputs the sound collection results to the external device via the connection part.

(17)

The sound collection device according to (16),

in which the external device is a device including the signal processing part.

(18)

The sound collection device according to (16), in which

the external device is another sound collection device, and

the signal output unit indirectly outputs the sound collection results to the signal processing part via the other sound collection device connected with the connection part.

(19)

The sound collection device according to any one of (16) to (18),

in which the connection part is installed such that the external device is connected with at least any end of the supporting member in the long-length direction.

(20)

The sound collection device according to any one of (1) to (19),

in which the supporting member supports a plurality of sound output parts at respective positions different from each other along the long-length direction, the plurality of sound output parts outputting sounds of frequency bands different from frequency bands of sounds collected by the sound collection parts, toward the one side in the long-length direction.

(21)

The sound collection device according to any one of (1) to (20),

in which the signal processing part suppresses a sound collection result of a sound coming from the other side that is different from the one side of the long-length direction.

### REFERENCE SIGNS LIST

1 sound collection device
10 sound collection unit
111 sound collection part
113 supporting member
131 supporting member
133 supporting member
135 rotation part
151 light-emitting part
171 speech detection part
191 sound output part
20 wearable part
21 guide member
30 driver holder
31 driver
311 microphone amplifier and ADC
312 signal processing part
313 signal processing unit
314 digital filter
315 mixer
316a, 315b switch
317 communication part
318 DAC and power amplifier
319 sound output part
321 serializer
323 de-serializer
33, 34 sound guide pipe
36 plug part
37 jack part

1. A sound collection device comprising:
a plurality of sound collection parts;
a supporting member that has a long shape and that supports the plurality of sound collection parts at respective positions different from each other along a long-length direction; and
a signal output part that directly or indirectly outputs sound collection results of respective sounds obtained by the plurality of sound collection parts to a signal processing part that acquires a target sound coming from one side of the long-length direction on a basis of the sound collection results.

2. The sound collection device according to claim 1,
wherein the supporting member is worn on a predetermined body part of a user, and the supporting member supports the plurality of sound collection parts such that a predetermined positional relation is established between the body part and each of the sound collection parts.

3. The sound collection device according to claim 2, wherein
the body part is a head, and
the supporting member is worn on the head such that the one side of the long-length direction substantially matches a front side of the user.

4. The sound collection device according to claim 2, comprising
a sound output part that outputs a sound based on the target sound acquired by the signal processing part.

5. The sound collection device according to claim 4, comprising
a wearable part that supports each of the sound output part and the supporting member near an ear of the user such that a predetermined positional relation is established between the ear and each of the sound output part and the supporting member.

6. The sound collection device according to claim 5,
wherein the wearable part includes a tubular sound guide part that guides a sound output from the sound output part to a vicinity of an ear opening.

7. The sound collection device according to claim 6, wherein
the wearable part includes a long member installed such that the long member extends along a back side of an auricle when the sound collection device is worn, and
the supporting member is connected with one end of the long member in a long-length direction, and the sound guide part is installed at the other end thereof.

8. The sound collection device according to claim 7,
wherein the wearable part includes a driving part at at least a portion of the long member, the driving part driving the sound output part.

9. The sound collection device according to claim 2, comprising:
a vibration part that outputs vibration based on the target sound acquired by the signal processing part, and
a wearable part that supports each of the vibration part and the supporting member such that the vibration part is in contact with at least a portion of a head of the user.

10. The sound collection device according to claim 1,
wherein the supporting member includes
a first member that supports the plurality of sound collection parts,
a second member that is different from the first member, and
a rotation part that rotatably connects the first member with the second member.

11. The sound collection device according to claim 1,
wherein at least a portion of the supporting member is capable of stretching and shortening in the long-length direction.

12. The sound collection device according to claim 11,
wherein a number of the sound collection parts to be activated changes when at least a portion of the supporting member stretches or shortens in the long-length direction.

13. The sound collection device according to claim 1, comprising
a plurality of the supporting members that support the plurality of sound collection parts.

14. The sound collection device according to claim 1,
wherein the supporting member supports the plurality of sound collection parts such that, among intervals between the plurality of sound collection parts, at least an interval between adjacent sound collection parts is different from other intervals.

15. The sound collection device according to claim 1, comprising
the signal processing part.

16. The sound collection device according to claim 1, comprising
a connection part that is connected with an external device,
wherein the signal output part outputs the sound collection results to the external device via the connection part.

17. The sound collection device according to claim 16,
wherein the external device is a device including the signal processing part.

18. The sound collection device according to claim 16, wherein
the external device is another sound collection device, and
the signal output unit indirectly outputs the sound collection results to the signal processing part via the other sound collection device connected with the connection part.

19. The sound collection device according to claim 16,
wherein the connection part is installed such that the external device is connected with at least any end of the supporting member in the long-length direction.

20. The sound collection device according to claim 1,
wherein the supporting member supports a plurality of sound output parts at respective positions different from each other along the long-length direction, the plurality of sound output parts outputting sounds of frequency bands different from frequency bands of sounds collected by the sound collection parts, toward the one side in the long-length direction.
